(19) United States
(12) Patent Application Publication
(10) Pub. No.: US 2018/0181316 A1
(43) Pub. Date: Jun. 28, 2018

(54) APPARATUS AND METHOD TO STORE DE-DUPLICATED DATA INTO STORAGE DEVICES WHILE SUPPRESSING LATENCY AND COMMUNICATION LOAD

(71) Applicant: FUJITSU LIMITED, Kawasaki-shi (JP)

(72) Inventors: Kosuke Suzuki, Ota (JP); Jun Kato, Kawasaki (JP); Hiroki Ohtsuji, Yokohama (JP)

(73) Assignee: FUJITSU LIMITED, Kawasaki-shi (JP)

(21) Appl. No.: 15/835,679

(22) Filed: Dec. 8, 2017

(30) Foreign Application Priority Data
Dec. 28, 2016 (JP) 2016-255820

(51) Int. Cl. G06F 3/06; G06F 17/30

(52) U.S. Cl. CPC G06F 3/0608; G06F 3/0641; G06F 3/0619; G06F 3/0611; G06F 3/0689; G06F 17/3015

(57) ABSTRACT

Apparatuses are coupled to each other to enable data de-duplicated by post-process processing or inline processing to be stored in a distributed manner into storage devices provided for the apparatuses. An apparatus stores apparatus-information identifying the apparatuses and performance-information of the post-process processing and the inline processing. Upon receiving an instruction for storing target-data into a storage destination, the apparatus calculates, based on a size of the target-data, the performance-information, and the apparatus-information, a first-size of first-data for the post-process processing and a second-size of second-data for the inline processing such that latency by the post-process processing and latency by the inline processing are balanced with each other. The apparatus instructs a first-apparatus including management information of the target-data, to execute the post-process processing on the first-data, and instructs at least one second-apparatus other than the first-apparatus to execute the inline processing on the second-data.

### CROSS-REFERENCE TO RELATED APPLICATION

This application is based upon and claims the benefit of priority of the prior Japanese Patent Application No. 2016-255820, filed on Dec. 28, 2016, the entire contents of which are incorporated herein by reference.

### FIELD

The embodiments discussed herein are related to apparatus and method to store de-duplicated data into storage devices while suppressing latency and communication load.

### BACKGROUND

In recent years, along with reduction in price and improvement in performance, there is an all flash array (AFA) in which a solid state drive (SSD) that uses a flash memory is incorporated in place of a hard disk drive (HDD) in a storage device as a storage apparatus. Further, development of a software defined storage (SDS) that is a storage apparatus that uses a general-purpose information processing apparatus or a general-purpose operating system (OS), without using a dedicated hardware of the storage apparatus is progressing.

There is a multi-node storage apparatus in which an AFA and an SDS are combined to implement a storage apparatus from a plurality of information processing apparatus. The multi-node storage apparatus is a storage apparatus in which a plurality of information processing apparatus (nodes) are coupled to each other by an InfiniBand interconnect while the storage apparatus is coupled to a server, which requests storage of data, by a fiber channel such that data are stored in a distributed manner into storage devices provided in the respective nodes.

Although the SSD used in the AFA is advantageous in comparison with the HDD in that the access speed is high, it is disadvantageous in that it has a limited number of times of writing and is not long in device life. Further, the SSD is disadvantageous in comparison with the HDD in that the unit price per data capacity is high. As a technology that makes up for the disadvantages of the SSD, a technology for de-duplication is used.

The de-duplication is a technology that does not write same data in an overlapping relationship into a storage device. The processing for de-duplication is processing for determining a hash value of target data to be stored, deciding whether or not data of the equal hash value is already stored in the storage device, and does not store the target data if data of the equal hash value is already stored but stores the target data if data of the equal hash value is not stored. It is to be noted that, as a method for determining a hash value, there is a method that uses a hash function such as secure hash algorithm-1 (SHA-1). Where the technology for de-duplication is used, it is possible for the AFA to decrease the number of times of writing to extend the device life of the SSD and lower the unit price per data capacity.

As a technology that uses de-duplication in a storage device, there are an inline method (hereinafter referred to as inline processing) and a post process method (hereinafter referred to as post process processing). The inline processing is processing for performing de-duplication of data before the data are written into a storage device. The post process processing is processing for performing de-duplication of data after the data are written into a storage device.

Examples of the related art include International Publication Pamphlet Nos. WO 2016/088258 and WO 2015/097756.

### SUMMARY

According to an aspect of the embodiments, an apparatus is provided in an information processing system in which a plurality of apparatuses are coupled to each other through a network so as to enable data de-duplicated by post process processing or inline processing to be stored in a distributed manner into storage devices provided for the plurality of apparatuses. The apparatus stores apparatus information identifying the plurality of apparatuses and performance information of post process processing and inline processing in the apparatus. Upon reception of a storage instruction for storing storage target data into a storage destination, the apparatus calculates, based on a data size of the storage target data, the performance information, and the apparatus information, a first data size of first data that is a processing target in the post process processing and a second data size of second data that is a processing target in the inline processing such that first latency by the post process processing and second latency by the inline processing are balanced with each other, and specifies a first apparatus including management information of the storage target data from the storage destination. The apparatus instructs the first apparatus to execute the post process processing whose processing target is the first data of the first data size within the storage target data, and instructs at least one second apparatus other than the first apparatus to execute the inline processing whose processing target is the second data of the second data size within the storage target data.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a configuration of an information processing apparatus, according to an embodiment;

FIG. 2 is a diagram illustrating an example of a configuration of a storage system, according to an embodiment;

FIG. 3 is a diagram illustrating an example of a hardware configuration of a storage apparatus, according to an embodiment;

FIG. 4 is a diagram illustrating an example of an outline of mapping of addresses and data, according to an embodiment;

FIG. 5 is a diagram illustrating an example of an operational sequence between different storage apparatuses, according to an embodiment;

FIG. 6 is a diagram illustrating an example of an operational sequence of inline processing, according to an embodiment;

FIG. 7 is a diagram illustrating an example of an operational sequence of post process processing, according to an embodiment;

FIG. 8 is a diagram illustrating an example of a relationship between latency and a write data size, according to an embodiment;

FIG. 9 is a diagram illustrating an example of an operational flowchart of data write processing, according to an embodiment;

FIG. 10 is a diagram illustrating an example of an operational flowchart of data write processing, according to an embodiment;

FIG. 11 is a diagram illustrating an example of an operational flowchart of data write processing, according to an embodiment; and

FIG. 12 is a diagram illustrating an example of an operational flowchart of data write processing, according to an embodiment.

### DESCRIPTION OF EMBODIMENTS

Since the inline processing de-duplicates data before writing and performs response of write completion after the data are written into the storage device, the latency (response time period from the write request to the response of a result) is longer than that by the post process processing because the response time period includes the period of time for the de-duplication processing.

Since the post process processing de-duplicates data written in the storage device after response of write completion, the period of time for the de-duplication processing is not included in the response time period and the latency is shorter than that by the inline processing. However, in the multi-node storage apparatus, improvement in performance may not necessarily be achieved by executing, when de-duplication is performed to store data, the post process processing in all nodes. The reason is that, if the post process processing is executed in the multi-node storage apparatus, inter-node communication for updating a pointer that points to a cache page for data before storage into the storage device and to the data stored in the storage device increases and the load involved in the inter-node communication increases.

It is preferable to suppress the latency in processing for de-duplication when data are stored into storage devices and the load by communication between different information processing apparatus.

In the following, embodiments are described in detail with reference to the drawings.

### First Embodiment

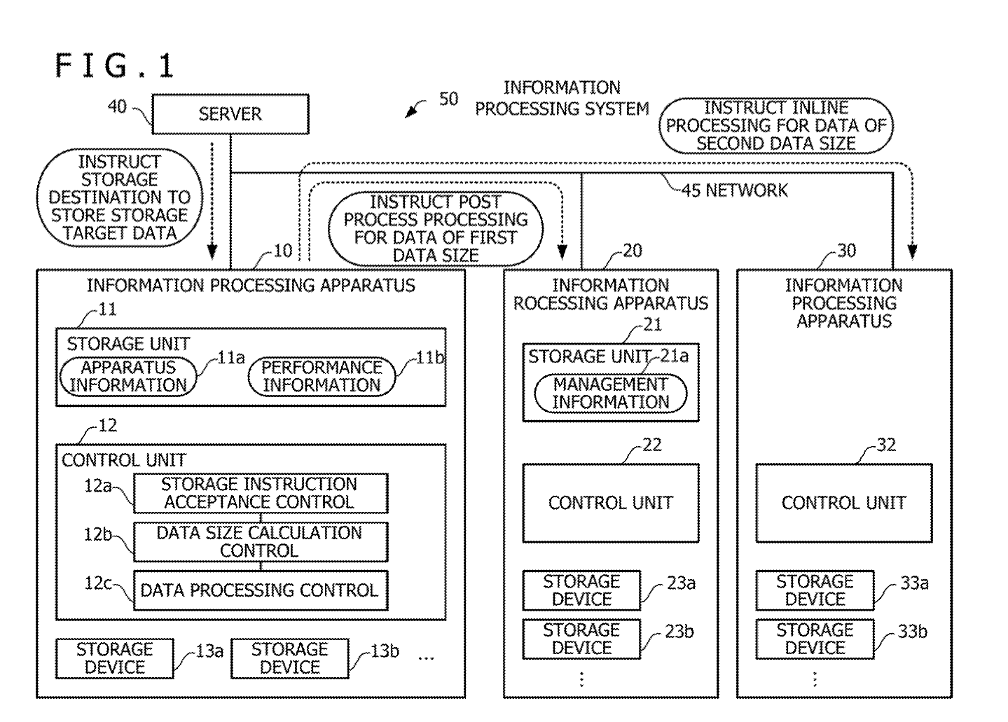

First, an information processing system of a first embodiment is described with reference to FIG. 1. FIG. 1 is a view depicting an example of an information processing system of the first embodiment.

An information processing system 50 is an system that includes information processing apparatus 10, 20, 30, . . . and a server 40 that are coupled to each other through a network 45. The information processing system 50 may store data, which are de-duplicated by post process processing or inline processing, into storage devices 13a, 13b, 23a, 23b, 33a, 33b, . . . which the information processing apparatus 10, 20, 30, . . . include, in a distributed manner. In the information processing system 50, the server 40 issues an instruction to the information processing apparatus 10 to store storage target data. The information processing apparatus 10 issues an instruction to the information processing apparatus 20 and 30 to store de-duplicated data in a distributed manner into the storage devices 13a, 13b, 23a, 23b, 33a, 33b, . . . .

Here, the information processing apparatus 10 is an information processing apparatus that receives a storage instruction to store storage target data from the server 40. The storage instruction includes address information of the storage devices 13a, . . . that are storage destinations of the storage target data. The information processing apparatuses 20 and 30 are information processing apparatuses that receive an instruction to store data from the information processing apparatus 10 by post process processing or inline processing.

Each of the information processing apparatuses 10, 20, and 30 is an information processing apparatus that includes a storage device and is, for example, a server that operates as a storage apparatus, a flash storage apparatus, or an SDS.

The information processing apparatus 10 includes a storage unit 11, a control unit 12, and one or more storage devices 13a, 13b, . . . capable of storing data.

The storage unit 11 is capable of storing apparatus information 11a and performance information 11b and is a suitable one of various memories such as a random access memory (RAM). The apparatus information 11a is information capable of specifying an information processing apparatus, from among a plurality of information processing apparatus 10, . . . , that is to execute processing for storing storage target data in a distributed manner. For example, the apparatus information 11a is information capable of specifying an execution target apparatus that is an information processing apparatus that becomes an execution target of post process processing or inline processing.

The performance information 11b is performance information of post process processing or inline processing in the information processing apparatus 10, . . . . The performance information 11b is information capable of being specified from a performance value when post process processing and inline processing are executed by the information processing apparatus 10, . . . . The storage unit 11 stores the performance information 11b in advance.

The control unit 12 receives a storage instruction to store storage target data from the server 40 and calculates a given data size. The control unit 12 issues an instruction to the information processing apparatus 20 and 30 to execute post process processing or inline processing whose processing target is the storage target data after divided for each given data size.

Each of the storage devices 13a, 13b, . . . is a device for storing data and is, for example, an SSD or an HDD. The storage devices 13a, 13b, . . . may be configured as a redundant arrays of independent disks (RAID).

The control unit 12 performs storage instruction acceptance control 12a, data size calculation control 12b, and data processing control 12c.

The storage instruction acceptance control 12a is control for accepting a storage instruction to store storage target data into a storage destination from the server 40. The storage instruction is a command for storing storage target data and is, for example, a write command. The storage destination is information capable of specifying a storage position of the storage target data in the storage device 13a, . . . and is, for example, address information.

The data size calculation control 12b is control for calculating a first data size and a second data size such that the latency in post process processing and the latency in inline processing may be balanced. The first data size is a data size of a processing target in post process processing. The second data size is a data size of a processing target in inline processing. The first data size and the second data size are calculated from the data size of the storage target data, the performance information 11b, and the apparatus information 11a.

The data processing control 12c is control for specifying an information processing apparatus 20 by which host process processing is to be executed and for issuing an instruction to the information processing apparatus 20 to execute post process processing in which data of the first data size is a processing target. The information processing apparatus 20 is specified from a storage destination included in the storage instruction. The information processing apparatus 20 is an information processing apparatus that includes management information 21a of storage target data. Further, the data processing control 12c is control for issuing an instruction to a different information processing apparatus 30 to execute inline processing in which data of the second data size are a processing target. The different information processing apparatus 30 is an information processing apparatus other than the information processing apparatus 20 specified from the storage destination from among a plurality of information processing apparatus included in the information processing system 50.

The information processing apparatus 20 includes a storage unit 21, a control unit 22, and one or more storage devices 23a, 23b, . . . capable of storing data. The storage unit 21 is capable of storing the management information 21a and is a suitable one of various memories such as a RAM. The management information 21a is information including address information indicative of a storage destination of storage target data and pointer information that points to the storage destination of the data of the storage target.

The control unit 22 receives an instruction to execute post process processing from the information processing apparatus 10 and executes post process processing whose processing target is data of the first data size. The storage devices 23a, 23b, . . . are similar to the storage devices 13a, 13b, . . . .

The information processing apparatus 30 includes a control unit 32 and one or more storage devices 33a, 33b, . . . capable of storing data. It is to be noted that description of storage units in the information processing apparatus 30 is omitted herein. The control unit 32 receives an instruction to execute inline processing from the information processing apparatus 10 and executes inline processing whose processing target is data of the second data size. The storage devices 33a, 33b, . . . are similar to the storage devices 13a, 13b, . . . .

Here, processing of the information processing apparatus 10 to store storage target data is described.

The control unit 12 accepts a storage instruction to store storage target data from the server 40 into a storage destination (storage instruction acceptance control 12a).

The control unit 12 calculates a first data size and a second data size from the data size of the storage target data, the performance information 11b, and the apparatus information 11a (data size calculation control 12b). Along with this, the control unit 12 calculates the first data size and the second data size such that the latency in the post process processing and the latency in the inline processing may be balanced (data size calculation control 12b).

The control unit 12 specifies the information processing apparatus 20 from the storage destination (data processing control 12c). For example, the control unit 12 specifies an information processing apparatus that includes the management information 21a including the storage destination (for example, address information) (data processing control 12c). The control unit 12 issues an instruction to the information processing apparatus 20 to execute post process processing (data processing control 12c). The control unit 12 issues an instruction to the information processing apparatus 30 to execute inline processing (data processing control 12c). The control unit 12 divides the storage target data into data of the first data size and data of the second data size and determines the data of the first data size as a processing target in the post process processing (data processing control 12c). Further, the control unit 12 determines the data of the second data size as a processing target in the inline processing (data processing control 12c).

The information processing apparatus 20 receives the instruction to execute post process processing from the information processing apparatus 10 and executes post process processing whose processing target is the data of the first data size. The information processing apparatus 20 transmits a processing completion notification of the post process processing to the information processing apparatus 10.

The information processing apparatus 30 receives the instruction to execute inline processing from the information processing apparatus 10 and executes inline processing whose processing target is the data of the second data size. The information processing apparatus 30 transmits a processing completion notification of the inline processing to the information processing apparatus 10.

The information processing apparatus 10 receives a processing completion notification from each of the information processing apparatuses 20 and 30. The information processing apparatus 10 transmits a response that storage of the storage target data is completed to the server 40.

Since the information processing apparatus 10 determines data sizes such that the latency in post process processing and the latency in inline processing may be balanced, and the data are stored in a distributed manner into the information processing apparatus 10, . . . , the latency may be suppressed. For example, since data are processed by distributed processing by weighting the data sizes such that the post process processing having a shorter latency than the inline processing processes an amount of data greater than the amount of data processed by the inline processing, the latency may be suppressed by the information processing system 50 as a whole.

Further, the information processing apparatus 10 specifies the information processing apparatus 20 including the management information 21a from the storage destination and instructs the information processing apparatus 20 to execute post process processing. Consequently, the information processing apparatus 10 causes the information processing apparatus 20, which includes the management information 21a, to execute post process processing. The management information 21a included in the information processing apparatus 20 includes pointer information that points to a storage destination of storage target data. The information processing apparatus 10 thereby achieves suppression of the load of communication between the information processing apparatus 10 and other apparatus, which occurs because pointer information that is produced when post process processing is executed is updated.

In this manner, the information processing system 50 may provide an information processing apparatus, an information processing method, and a data management program by which the latency involved in processing for de-duplication when data are stored into storage devices and the load of communication between different information processing apparatuses may be suppressed.

### Second Embodiment

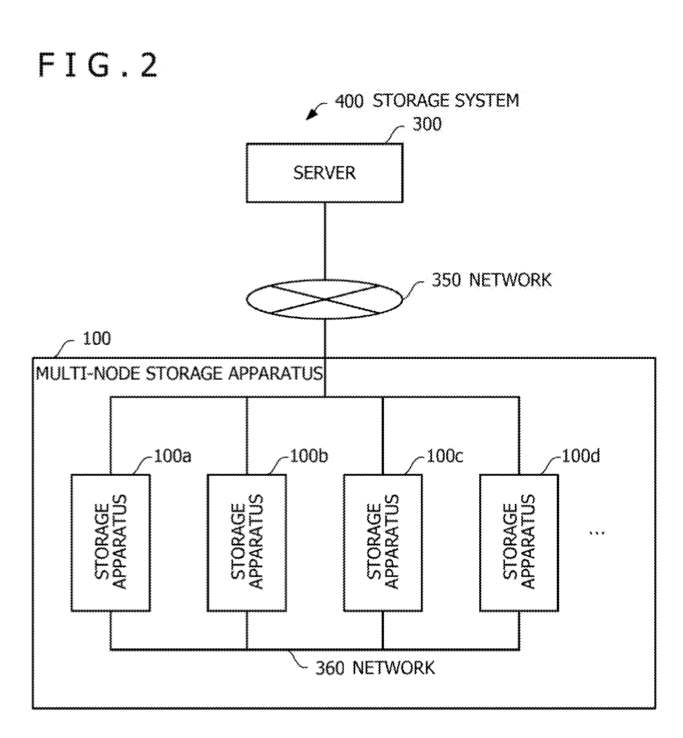

Now, a storage system in which the information processing apparatus 10 and so forth are applied to a storage apparatus is described as a second embodiment with reference to FIG. 2. FIG. 2 is a view depicting an example of a configuration of a storage system of the second embodiment.

The storage system 400 includes a server 300, and a multi-node storage apparatus 100 coupled to the server 300 through a network 350.

In the storage system 400, the server 300 transmits a request for writing of data to the multi-node storage apparatus 100, and the multi-node storage apparatus 100 de-duplicates and stores the received data into storage devices. In the storage system 400, although a FiberChannel network may be used as the network 350 and an InfiniBand interconnect may be used as a network 360, they are examples and some other networks may be used.

The server 300 is a computer that issues a request for reading out or writing of data from or into the multi-node storage apparatus 100 through the network 350.

The multi-node storage apparatus 100 includes a plurality of storage apparatuses 100a, 100b, 100c, 100d, . . . . The storage apparatuses 100a, 100b, 100c, 100d, . . . may be storage apparatuses for exclusive use or may each be an SDS. The storage apparatuses 100a, 100b, 100c, 100d, . . . receive data and a command for data write processing from the server 300 through the network 350 and transmit a response to the data write processing. The storage apparatuses 100a, 100b, 100c, 100d, . . . transmit and receive data or an instruction for data storage between the storage apparatuses via the network 360. Further, the storage apparatuses 100a, 100b, 100c, 100d, . . . store received data into the storage devices.

The multi-node storage apparatus 100 controls input/output (I/O) to a storage device provided in each of the storage apparatuses 100a, . . . of the multi-node storage apparatus 100 in response to a data I/O request from the server 300. For example, when the storage apparatus 100a included in the multi-node storage apparatus 100 receives data and a write command from the server 300, the storage apparatus 100a transmits the received data and the data write command to each of the storage apparatuses 100b, . . . .

A command for requesting I/O, which is transmitted and received by the server 300 and the multi-node storage apparatus 100, is prescribed, for example, in small computer system interface (SCSI) architecture model (SAM), SCSI primary commands (SPCs), SCSI block commands (SBCs) and so forth. Information regarding the command is described, for example, in a command description block (CDB). As a command relating to reading out or writing of data, for example, there are a Read command and a Write command. A command may include a logical unit number (LUN) or a logical block address (LBA) in which data of a target for reading out or writing is stored, the number of blocks for data of a target of reading out or writing, and so forth.

By such a configuration of the system as described above, processing functions of second to fifth embodiments may be implemented. It is to be noted that also the information processing system 50 indicated in the first embodiment may be implemented by a system similar to the storage system 400 depicted in FIG. 2.

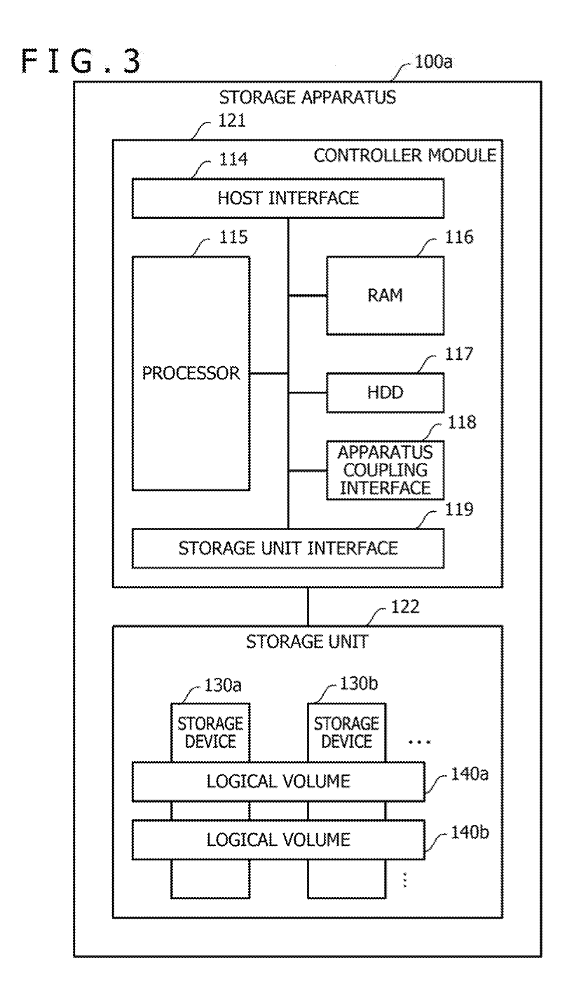

Now, a hardware configuration of the storage apparatus 100a is described with reference to FIG. 3. FIG. 3 is a view depicting an example of a hardware configuration of a storage apparatus of the second embodiment.

The storage apparatus 100a includes a controller module 121 and a storage unit 122. The storage apparatus 100a may include a plurality of controller modules 121 and a plurality of storage units 122. It is to be noted that also the storage apparatuses 100b, 100c, 100d, . . . may be implemented by similar hardware.

The controller module 121 includes a host interface 114, a processor 115, a RAM 116, an HDD 117, an apparatus coupling interface 118, and a storage unit interface 119.

The controller module 121 is controlled wholly by the processor 115. The RAM 116 and a plurality of peripheral apparatuses are coupled to the processor 115 via a bus. The processor 115 may be a multi-core processor including two or more processors. It is to be noted that, in a case where there are a plurality of controller modules 121, the controller modules 121 may have a master-slave relationship such that the processor 115 of the controller module 121 that serves as a master controls the controller module or modules 121 that serve as a slave or slaves and the overall storage apparatus 100a.

The processor 115 may be, for example, a central processing unit (CPU), a micro processing unit (MPU), a digital signal processor (DSP), an application specific integrated circuit (ASIC), or a programmable logic device (PLD).

The RAM 116 is used as a main storage device of the controller module 121. The RAM 116 may have a plurality of memory chips incorporated therein and may be, for example, a dual inline memory module (DIMM). Into the RAM 116, at least part of a program of an OS or an application program to be executed by the processor 115 is temporarily stored. Further, into the RAM 116, various data to be used in processing by the processor 115 are stored. Further, the RAM 116 functions as a cache memory of the processor 115. Furthermore, the RAM 116 functions also as a cache memory for temporarily storing data before being written into storage devices 130a, 130b, . . . .

Peripheral apparatuses coupled to the bus include the host interface 114, the HDD 117, the apparatus coupling interface 118, and the storage unit interface 119. The host interface 114 performs transmission and reception of data to and from the server 300 through a network 350.

The HDD 117 performs magnetically writing and reading out of data into and from a disk medium built therein. The HDD 117 is used as an auxiliary storage device of the storage apparatus 100a. Into the HDD 117, a program of an OS, an application program, and various data are stored. It is to be noted that, as the auxiliary storage device, a semiconductor storage device such as a flash memory may be used.

The apparatus coupling interface 118 is a communication interface for coupling a peripheral apparatus or the network 360 to the controller module 121. For example, a memory device or a memory reader-writer not depicted may be coupled to the apparatus coupling interface 118. The memory device is a recording medium in which a communication function with the apparatus coupling interface 118 is incorporated. The memory reader-writer is a device that performs writing of data into a memory card or reading out of data from a memory card. The memory card is a recording medium, for example, of the card type.

Further, the apparatus coupling interface 118 may couple an optical drive device not depicted. The optical drive device utilizes a laser beam or the like to perform reading out of data recorded on an optical disk. The optical disk is a portable recording medium on which data is recorded so as to be readable by reflection of light. As the optical disk, there are a digital versatile disc (DVD), a DVD-RAM, a compact disk read only memory (CD-ROM), a CD-recordable (R)/rewritable (RW) and so forth. The storage unit interface 119 performs transmission and reception of data to and from the storage unit 122. The controller module 121 couples to the storage unit 122 through the storage unit interface 119.

The storage unit 122 includes one or more storage devices 130a, 130b, . . . and stores data in accordance with an instruction from the controller module 121. Each of the storage devices 130a, 130b, . . . is a device for storing data and is, for example, an SSD.

One or more logical volumes 140a, 140b, . . . are set to the storage devices 130a, 130b, . . . . It is to be noted that the logical volumes 140a, 140b, . . . may be set across plural ones of the storage devices 130a, 130b, . . . . Data stored in the storage devices 130a, 130b, . . . may be specified from address information such as LUN or LBA.

The processing function of the storage apparatus 100a may be implemented by such a hardware configuration as described above.

The storage apparatus 100a executes a program recorded, for example, in a computer-readable recording medium to implement the processing function of the storage apparatus 100a. A program that describes the substance of processing to be executed by the storage apparatus 100a may be recorded in various recording media. For example, a program to be executed by the storage apparatus 100a may be stored in the HDD 117. The processor 115 loads at least part of the program in the HDD 117 into the RAM 116 and executes the program. Alternatively, a program to be executed by the storage apparatus 100a may be recorded in a portable recording medium such as an optical disk, a memory device, or a memory card. A program stored in a portable recording medium is installed into the HDD 117 and then enabled for execution under the control of the processor 115, for example. Further, the processor 115 may read out a program directly from a portable recording medium and execute the program.

The processing functions of the second to fifth embodiments may be implemented by such a hardware configuration as described above. It is to be noted that also the information processing apparatus 10 indicated in the first embodiment may be implemented by hardware similar to that of the storage apparatus 100a depicted in FIG. 3.

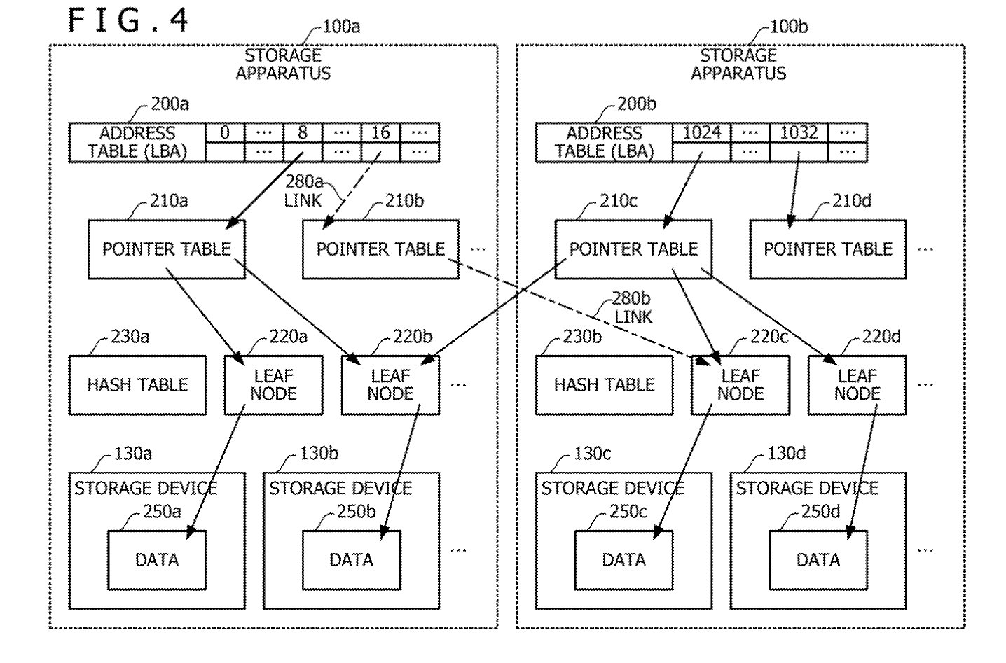

Now, mapping of addresses and data in the second embodiment is described with reference to FIG. 4. FIG. 4 is a view depicting an outline of mapping between addresses and data in the second embodiment.

Mapping of addresses and data is a corresponding relationship between addresses and data represented by a tree structure in which a pointer that points to data is used. The addresses are addresses (LBAs) of data stored in the storage devices 130a, 130b, 130c, 130d, . . . . It is to be noted that, although an address is used also when data stored already is to be read out, description here is given of write processing when the storage apparatus 100a receives data from the server 300 and the storage apparatus 100b stores the data. It is to be noted that the storage apparatus 100a, 100b, . . . store unit data, which are obtained by separating data received from the server 300 into data of a given size, into the storage devices 130a, 130b, 130c, 130d, . . . . The unit data is a processing unit in the respective storage apparatuses 100a, 100b, . . . . Each of the storage apparatuses 100a, . . . calculates a hash value for each unit data and executes de-duplication for each unit data.

The tree structure in the storage apparatus 100a is configured by linking an address table 200a, pointer tables 210a, 210b, . . . , leaf nodes 220a, 220b, 220c, 220d, . . . , and data 250a, 250b, . . . . The tree structure in the storage apparatus 100b is configured by linking an address table 200b, pointer tables 210c, 210d, . . . , leaf nodes 220a, 220b, 220c, 220d, . . . , and data 250c, 250d, . . . . It is to be noted that the links between the pointer tables 210a, 210b, 210c, 210d, . . . and the leaf nodes 220a, 220b, 220c, 220d, . . . sometimes extend across the storage apparatus 100a, 100b, . . . . The links, respective tables, and leaf nodes 220a, 220b, 220c, 220d, . . . that configure the tree structures are stored into memories such as the RAMs 116 of the storage apparatus 100a, 100b, . . . .

The address table 200a is a table that manages corresponding relationships between addresses into which data is to be stored and the pointer tables 210a, 210b, . . . . The address table 200a includes a pointer that points to one of the pointer tables 210a, 210b, . . . corresponding to an address. For example, in a case where the address table 200a corresponds to the LBAs “0” to “1023,” the storage apparatus 100a is a storage apparatus that stores routes of a tree structure that follow data stored in the LBAs “0” to “1023.” Meanwhile, the address table 200b is a table for managing a corresponding relationship between addresses for storing data and pointer tables 210c, 210d, . . . . The address table 200b includes a pointer that points to one of the pointer tables 210c, 210d, . . . corresponding to an address. For example, in a case where the address table 200b corresponds to the LBAs “1024” to “2047,” the storage apparatus 100b is a storage apparatus that stores routes of a tree structure that follow data stored in the LBAs “1024” to “2047.”

The address tables 200a, 200b, . . . exist for the respective storage apparatuses 100a, 100b, . . . such that the addresses are successive addresses. For example, the storage apparatus 100a includes the address table 200a corresponding to the LBAs “0” to “1023,” and the storage apparatus 100b includes the address table 200b that corresponds to the LBAs “1024” to “2047.” For example, in response to an address of data to be stored, the address table 200a, 200b, . . . that is the root of the tree structure is determined, and also the storage apparatus 100a, 100b, . . . that includes the address table 200a, 200b, . . . is determined.

The pointer tables 210a, 210b, . . . are tables for managing a corresponding relationship between the address table 200a and the leaf nodes 220a, 220b, 220c, 220d, . . . . The pointer tables 210a, 210b, . . . include a pointer that points to one of the leaf nodes 220a, 220b, 220c, 220d, . . . . The pointer tables 210c, 210d, . . . are tables for managing a corresponding relationship between the address table 200b and the leaf nodes 220a, 220b, 220c, 220d, . . . . The pointer tables 210c, 210d, . . . include a pointer that points to one of the leaf nodes 220a, 220b, 220c, 220d, . . . . The pointer tables 210a, 210b, 210c, 210d, . . . are provided for the respective storage apparatuses 100a, 100b, . . . in a corresponding relationship to the address tables 200a, 200b, . . . .

The leaf nodes 220a, 220b, 220c, 220d, . . . are tables for managing a corresponding relationship between the pointer tables 210a, 210b, 210c, 210d, . . . and the data 250a, 250b, 250c, 250d, . . . . The leaf nodes 220a, 220b, 220c, 220d, . . . include a pointer that points to data stored in the storage devices 130a, 130b, 130c, 130d, . . . . Each of the leaf nodes 220a, 220b, 220c, 220d, . . . is provided in one of the storage apparatuses 100a, 100b, . . . in which data indicated by the pointer of the leaf node is stored.

Hash tables 230a, 230b, . . . are tables for managing hash values and link counters in association with each other. The hash tables 230a, 230b, . . . are provided for the respective storage apparatuses 100a, 100b, . . . . A hash value is a value for uniquely identifying data that is obtained using a function such as SHA-1 for each data stored in the storage apparatus 100a, 100b, . . . . The storage apparatuses 100a, 100b, . . . may decide that two pieces of data are same when hash values thereof are equal. A link counter is information for managing the number of links from the pointer table 210a, 210b, 210c, 210d, . . . to the leaf node 220a, 220b, 220c, 220d, . . . that points to unit data corresponding to a hash value. The value of the link counter is the number of times data pointed to by the pointer of the leaf node 220a, 220b, 220c, 220d, . . . is referenced. When the value of the link counter is “0,” this indicates that data corresponding to the hash value is not stored. When the value of the link counter is equal to or higher than “1,” this indicates that data corresponding to the hash value is stored already. In this manner, the hash tables 230a, 230b, . . . are used by the storage apparatuses 100a, 100b, . . . in order to store de-duplicated data.

Here, an outline of processing of the storage apparatus 100a for storing data received from the server 300 is described.

The storage apparatus 100a receives data and a write command from the server 300. It is assumed here that the address of the write destination of the received data is 16 (LBA).

The storage apparatus 100a divides the received data for each given size to produce unit data. In a case where the data size of the received data is 32 KB and the given size (data size of the unit data) is 8 KB, the storage apparatus 100a divides the received data into four pieces of unit data each being 8 KB. The storage apparatus 100a determines a hash value for each piece of divisional data by using a function such as SHA-1.

The storage apparatus 100a determines a storage apparatus into which data are to be stored from each hash value. For example, when the first digit of the hash value is “1,” the storage apparatus 100a may determine that the storage apparatus into which the data is to be stored is the storage apparatus 100b, and when the first digit of the hash value is “2,” the storage apparatus 100a may determine that the storage apparatus into which the data is to be stored is the storage apparatus 100c. It is assumed here that the storage apparatus 100a determines that the storage apparatus into which the data is to be stored is the storage apparatus 100b.

The storage apparatus 100a transmits the divisional unit data and the hash value to the storage apparatus 100b. Here, it is assumed that the unit data transmitted from the storage apparatus 100a to the storage apparatus 100b is the data 250c.

The storage apparatus 100b receives the unit data and the hash value from the storage apparatus 100a. The storage apparatus 100b refers to the hash table 230b and reads out the link counter corresponding to the received hash value.

If the value of the link counter is equal to or higher than “1,” in other words, if data having a hash value equal to the received hash value exists, the storage apparatus 100b transmits an instruction to update the tree structure to the storage apparatus 100a and increments the value of the link counter by “1.”

Here, since the leaf node 220c corresponding to the data 250c is already linked from the pointer table 210c, the storage apparatus 100b updates the value of the link counter corresponding to the hash value of the data 250c from “1” to “2.” Further, the storage apparatus 100b transmits an instruction to update the tree structure for the leaf node 220c to the storage apparatus 100a.

The storage apparatus 100a establishes links 280a and 280b in response to reception of the instruction to update the tree structure. For example, the storage apparatus 100a, which includes the address table 200a corresponding to the address (LBA) for the data to be stored, updates the link of the tree structure via which the data is accessed. The server 300 may access the data 250c, which is pointed to by the pointer of the leaf node 220c, by following the links 280a and 280b via the address table 200a.

In this manner, each of the storage apparatuses 100a, 100b, . . . may execute a write command of de-duplicated data without storing new data same as data stored already.

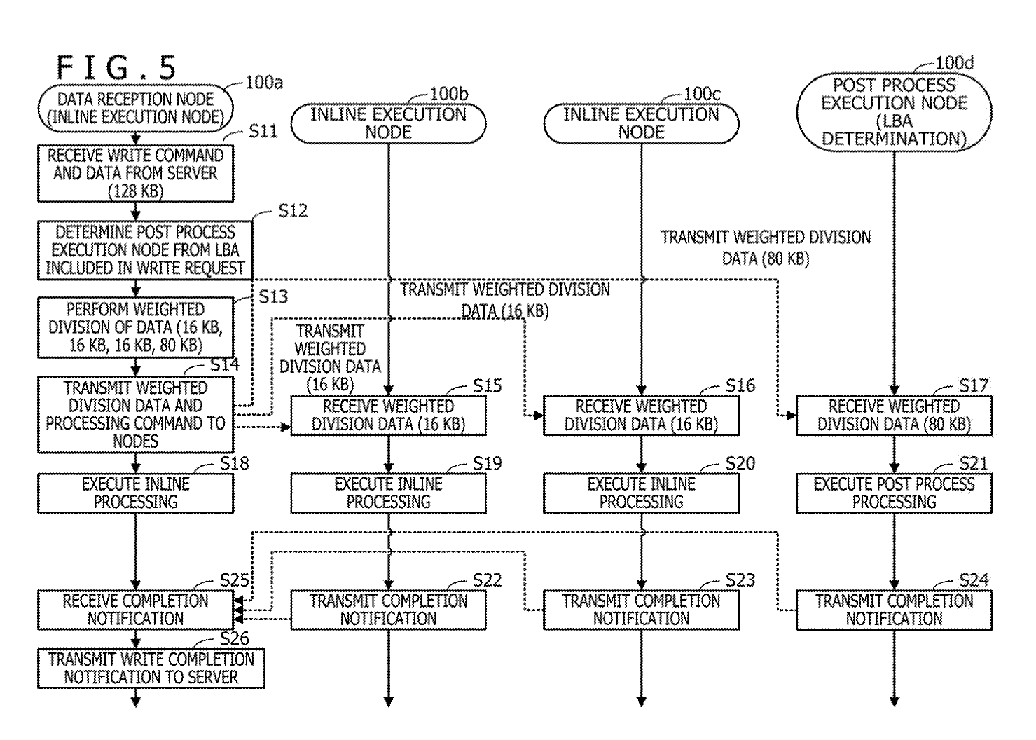

It is to be noted that details of processing for storing data in sharing by each of storage apparatuses 100a, 100b, . . . are hereinafter described with reference to FIG. 5.

Now, a sequence between storage apparatuses in the second embodiment is described with reference to FIG. 5. FIG. 5 is a view depicting an example of a sequence between storage apparatuses in the second embodiment.

A sequence in processing executed among the storage apparatuses 100a, 100b, 100c, 100d, . . . provided in the multi-node storage apparatus 100 is described.

In the following description, the storage apparatus 100a that receives data from the server 300 is referred to as data reception node 100a. Meanwhile, the storage apparatus 100b and 100c that execute inline processing are referred to as inline execution nodes 100b and 100c. Further, the storage apparatus 100d that executes post process processing is referred to as post process execution node. Further, each of the storage apparatuses 100a, 100b, 100c, 100d, . . . included in the multi-node storage apparatus 100 is referred to suitably as node.

The processing to be executed by the storage apparatus 100a is executed by a control unit (processor 115) provided in the storage apparatus 100a. The processing to be executed by the storage apparatus 100b is executed by a control unit (processor 115) provided in the storage apparatus 100b. The processing to be executed by the storage apparatus 100c is executed by a control unit (processor 115) provided in the storage apparatus 100c. The processing to be executed by the storage apparatus 100d is executed by a control unit (processor 115) provided in the storage apparatus 100d.

[Step S11] The data reception node 100a receives a write command and data from the server 300. Here, it is assumed that the data reception node 100a receives data of 128 KB.

[Step S12] The data reception node 100a determines a post process execution node from an LBA included in the received write command. Here, it is assumed that the data reception node 100a determines the storage apparatus 100d as the post process execution node 100d.

Here, the reason why a post process execution node is determined from the LBA included in the write command received by the data reception node 100a is that it is intended to suppress the load inter-node communication.

In the multi-node storage apparatus 100, usually a node that executes post process processing, a node that creates a temporary cache page before data storage and updates the tree structure for data access, and a node that stores the data are different from one another. The temporary cache page is cache page that is created by a node determined from an LBA included in a write command before a node that stores data creates a cache page. Since the node that executes post process processing transmits an instruction to create a temporary cache page and an instruction to update a link of the tree structure, inter-node communication with the node determined from the LBA may be required. However, if the node that executes post process processing and the node determined from the LBA are same, creation of a temporary cache page between such nodes and inter-node communication for updating of the tree structure for accessing to the temporary cache page may be reduced.

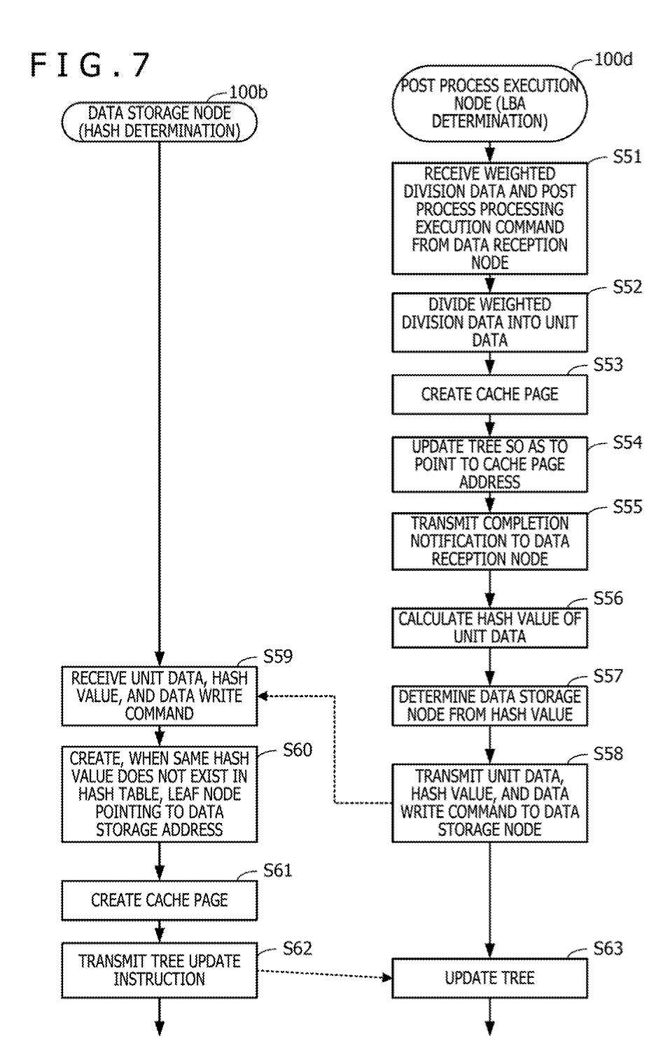

In this manner, the multi-node storage apparatus 100 may reduce inter-node communication required for executing post process processing. It is to be noted that details of the post process processing are hereinafter described with reference to FIG. 7.

[Step S13] The data reception node 100a performs weighted division of the data received from the server 300. In the following description, data obtained by weighted division of data received from the server 300 is referred to as weighted division data.

Here, it is assumed that the data reception node 100a divides the received data of 128 KB into four pieces of weighted division data of 16 KB, 16 KB, 16 KB, and 80 KB. Dividing data into pieces of weighted division data means dividing data with different sizes.

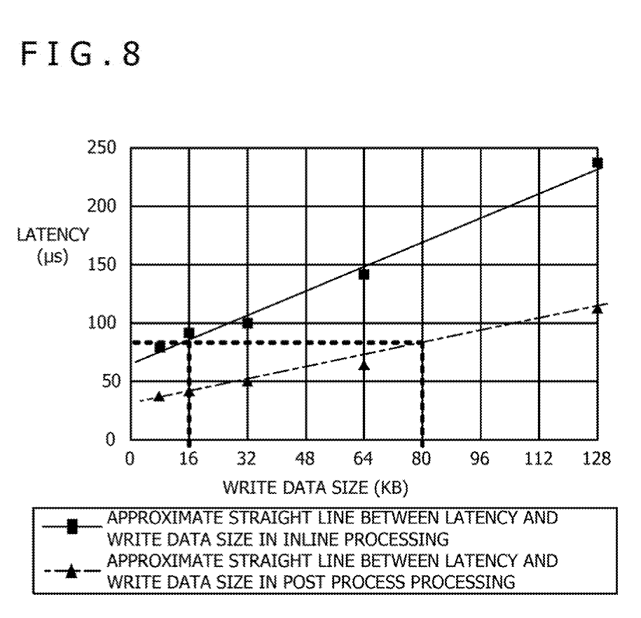

The data reception node 100a determines data sizes such that the latency of post process processing and the latency of inline processing may become substantially equal to each other, and divides the data with the determined data sizes. The weighting when the data reception node 100a performs weighted division of data is hereinafter described with reference to FIG. 8.

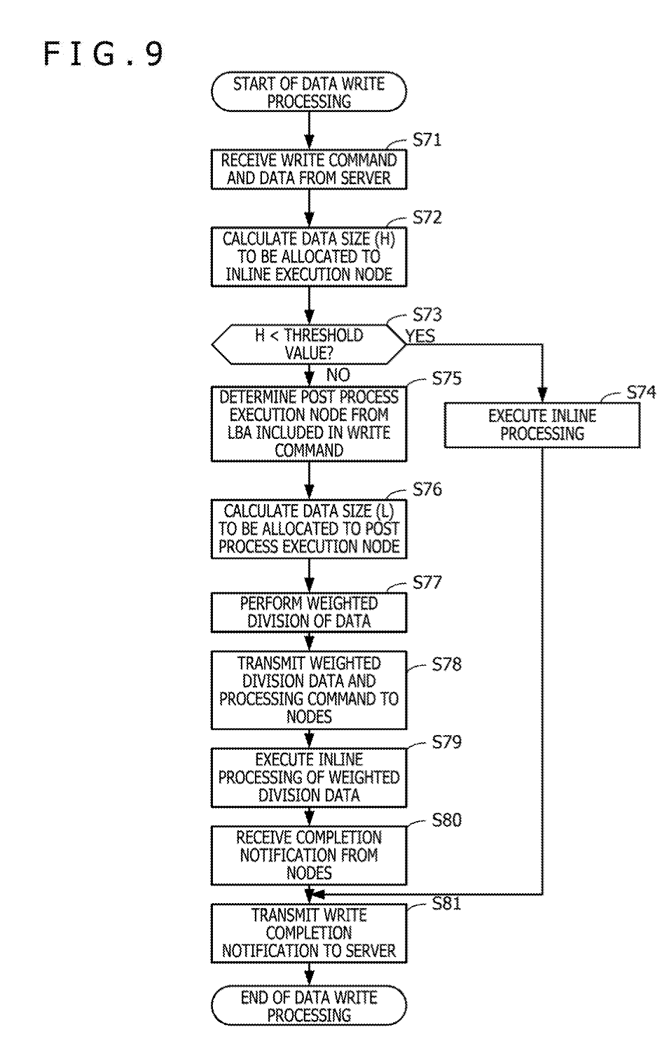

Further, while the present sequence indicates an example in which the data reception node 100a divides data received from the server 300 and processing of the data is executed by each node, the data received from the server 300 are sometimes processed without dividing the data in response to the data size or the like. Details of the processing of the data reception node 100a are hereinafter described with reference to FIGS. 9, 10, 11, and 12.

[Step S14] The data reception node 100a transmits the data obtained by the weighted division at step S13 to the respective nodes. The data reception node 100a transmits data (data size 80 KB) having the greatest data size from among the pieces of weighted division data and an execution command of post process processing to the post process execution node 100d. The data reception node 100a transmits data (data size 16 KB) other than the data of the greatest data size from among the pieces of weighted division data and an execution command of inline processing to the inline execution nodes 100b and 100c.

[Step S15] The inline execution node 100b receives the weighted division data (16 KB) from the data reception node 100a.

[Step S16] The inline execution node 100c receives the weighted division data (16 KB) from the data reception node 100a.

[Step S17] The post process execution node 100d receives the weighted division data (80 KB) from the data reception node 100a.

[Step S18] The data reception node 100a divides the weighted division data (16 KB) into pieces of unit data of a given size and executes inline processing for each piece of the unit data. For example, where the given size is 8 KB, the data reception node 100a divides the weight divisional data (16 KB) into two pieces of unit data (8 KB) and executes inline processing for each of the two pieces of unit data.

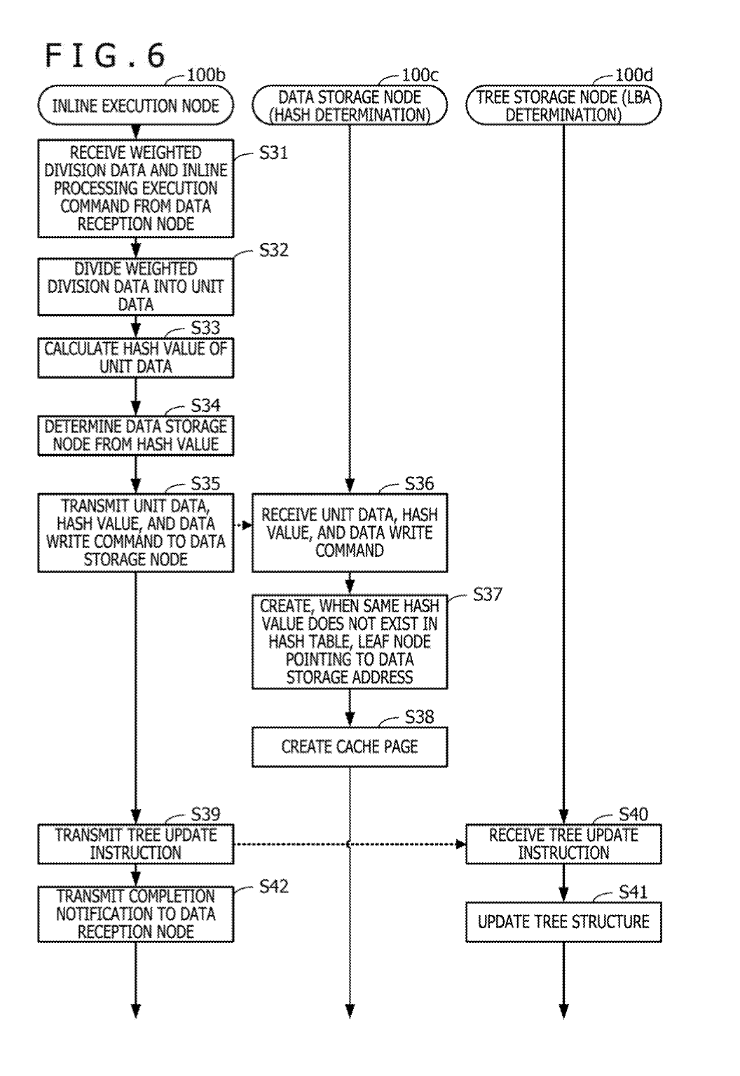

It is to be noted that details of the inline processing are hereinafter described with reference to FIG. 6.

[Step S19] The inline execution node 100b divides the weighted division data (16 KB) into pieces of unit data of the given size and executes inline processing for each of the pieces of unit data.

[Step S20] The inline execution node 100c divides the received weighted division data (16 KB) into pieces of unit data of the given size and executes inline processing for each of the pieces of unit data.

[Step S21] The post process execution node 100d divides the received weighted division data (80 KB) into pieces of unit data of a given size and executes post process processing for each of the pieces of unit data.

It is to be noted that details of the post process processing are hereinafter described with reference to FIG. 7.

[Step S22] The inline execution node 100b transmits a completion notification of the inline processing to the data reception node 100a.

[Step S23] The inline execution node 100c transmits a completion notification of the inline processing to the data reception node 100a.

[Step S24] The post process execution node 100d transmits a completion notification of the post process processing to the data reception node 100a.

[Step S25] The data reception node 100a receives the completion notifications from the respective nodes.

[Step S26] The data reception node 100a transmits a write completion notification to the server 300.

In this manner, the multi-node storage apparatus 100 performs weighted division of data received from the server 300, and each node may execute inline processing or post process processing by using the weighted division data. Since the multi-node storage apparatus 100 determines such data sizes that the latency of the post process processing and the latency of the inline processing become substantially equal to each other and performs weighted division of the data with the determined data sizes, the latency may be reduced from that where inline processing is performed otherwise by all the nodes.

Now, a sequence of inline processing in the second embodiment is described with reference to FIG. 6. FIG. 6 is a view depicting an example of a sequence of inline processing in the second embodiment.

Here, a sequence of inline processing executed among the storage apparatuses 100b, 100c, and 100d provided in the multi-node storage apparatus 100 is described.

In the following description, the storage apparatus 100b that executes inline processing is referred to as inline execution node 100b. Further, the storage apparatus 100c that stores unit data is referred to as data storage node 100c. Further, the storage apparatus 100d that updates the tree structure for accessing to data is referred to as tree storage node 100d. Note that it is assumed that the data reception node 100a determines the tree storage node 100d from an LBA included in a received write command. Also note that it is assumed that the data reception node 100a that receives a write command and data from the server 300 is omitted in FIG. 6.

The processing executed by the storage apparatus 100b is executed by a control unit (processor 115) provided in the storage apparatus 100b. The processing executed by the storage apparatus 100c is executed by a control unit (processor 115) provided in the storage apparatus 100c. The processing executed by the storage apparatus 100d is executed by a control unit (processor 115) provided in the storage apparatus 100d.

[Step S31] The inline execution node 100b receives the weighted division data and the execution command of inline processing from the data reception node 100a.

[Step S32] The inline execution node 100b divides the weighted division data into pieces of unit data. In a case where the data size of the weighted division data is 16 KB and the data size of unit data is 8 KB, the inline execution node 100b divides the weighted division data into pieces of unit data of 8-KB size.

[Step S33] The inline execution node 100b calculates a hash value of the unit data. It is to be noted that, in a case where plural pieces of unit data exist, the inline execution node 100b calculates a hash value for each of the plural pieces of unit data.

[Step S34] The inline execution node 100b determines a data storage node in which the unit data is to be stored from the hash value of the unit data. It is to be noted that, if the inline execution node 100b calculates a hash value for plural pieces of unit data at step S33, it determines, from each of the hash values, a data storage node that is to store the piece of unit data corresponding to the hash value.

Here, it is assumed that the inline execution node 100b determines the data storage node 100c as a storage apparatus that is to store the unit data.

[Step S35] The inline execution node 100b transmits the unit data, the hash value determined from the unit data, and a data write command to the data storage node 100c.

[Step S36] The data storage node 100c receives the unit data, the hash value determined from the unit data, and the data write command from the inline execution node 100b.

[Step S37] The data storage node 100c refers to the hash table provided in the data storage node 100c and generates, when a hash value equal to the received hash value does not exist in the hash table, a leaf node that includes a pointer that points to an address into which the received unit data is to be stored.

It is to be noted that, when a hash value equal to the received hash value exists in the hash table, since the unit data is stored already and also the leaf node has been created, the data storage node 100c omits the leaf node creation at the present step.

In this manner, the data storage node 100c performs de-duplication of data for each piece of unit data by using a hash value.

[Step S38] The data storage node 100c creates a cache page in which the received unit data is stored in a memory such as the RAM 116 provided in the data storage node 100c. Further, after the cache page is created, the data storage node 100c stores the unit data into the storage unit 122 provided in the data storage node 100c.

It is to be noted that, if a cache page in which the data is stored is created already and the data is stored in the storage unit 122, the data storage node 100c omits the processing for cache page creation and storage of the data at the present step.

[Step S39] The inline execution node 100b transmits a tree update instruction to the tree storage node 100d. For example, the inline execution node 100b transmits an instruction for linking to the leaf node that includes a pointer that points to the stored unit data.

[Step S40] The tree storage node 100d receives the tree update instruction from the inline execution node 100b.

[Step S41] The tree storage node 100d establishes, in accordance with the instruction received at step S40, a link that follows from the address table corresponding to the address of the data to the leaf node that includes the pointer that points to the stored unit data to update the tree structure.

[Step S42] The inline execution node 100b transmits a completion notification to the data reception node 100a and ends the inline processing.

Now, a sequence of post process processing in the second embodiment is described with reference to FIG. 7. FIG. 7 is a view depicting an example of a sequence of post process processing in the second embodiment.

A sequence of post processing executed between the storage apparatus 100b and 100d provided in the multi-node storage apparatus 100 is described.

In the following description, the storage apparatus 100b that stores unit data is referred to as data storage node 100b. The storage apparatus 100d that executes post process processing is referred to as post process execution node 100d.

Note that it is assumed that the data reception node 100a that receives a write command and data from the server 300 is omitted in FIG. 7.

The processing executed by the storage apparatus 100b is executed by a control unit (processor 115) provided in the storage apparatus 100b. The processing executed by the storage apparatus 100d is executed by a control unit (processor 115) provided in the storage apparatus 100d.

[Step S51] The post process execution node 100d receives weighted division data and an execution command of post process processing from the data reception node 100a.

Note that it is assumed that the data reception node 100a determines the tree storage node 100d from an LBA included in the received write command and transmits an instruction to the tree storage node 100d as the post process execution node 100d. Since the post process execution node 100d itself is the tree storage node 100d, address transmission of a cache page, transmission of data to be stored into the cache page, and inter-node communication for tree update instruction may be reduced.

[Step S52] The post process execution node 100d divides weighted division data into pieces of unit data. For example, where the data size of the weighted division data is 80 KB and the data size of the unit data is 8 KB, the post process execution node 100d divides the weighted division data into 10 pieces of unit data of the 8-KB size.

[Step S53] The post process execution node 100d creates a cache page for each piece of unit data.

The post process execution node 100d creates, in order to make it possible for the server 300 to access the unit data before the unit data are stored into the storage devices 130a, . . . , a cache page in which the unit data are stored, in a memory such as the RAM 116. It is to be noted that the cache page created at the present step is a temporary cache page described in the foregoing description of the processing at step S12.

[Step S54] The post process execution node 100d updates the tree structure such that the address of the cache page created at step S53 is pointed to. For example, the post process execution node 100d updates the pointer of the pointer table such that the pointer points to the address of the cache page.

[Step S55] The post process execution node 100d transmits a completion notification to the data reception node 100a.

[Step S56] The post process execution node 100d calculates a hash value of the unit data. It is to be noted that, in a case where plural pieces of unit data exist, the post process execution node 100d calculates a hash value for each of the plural pieces of unit data.

[Step S57] The post process execution node 100d determines a data storage node for storing the unit data from the hash value of the unit data. It is to be noted that, if the post process execution node 100d calculates a hash value for plural pieces of unit data at step S56, it determines, from each of the hash values, a data storage node that is to store one of the plural pieces of unit data corresponding to the hash value.

Here, it is assumed that the post process execution node 100d determines the data storage node 100b as a storage apparatus that is to store the unit data.

[Step S58] The post process execution node 100d transmits the unit data, the hash value determined from the unit data, and a data write command to the data storage node 100b.

[Step S59] The data storage node 100b receives the unit data, the hash value determined from the unit data, and the data write command from the post process execution node 100d.

[Step S60] The data storage node 100b refers to the hash table provided in the data storage node 100b and creates, when a hash value same as the received hash value does not exist in the hash table, a leaf node including a pointer that points to an address into which the received unit data is to be stored.

It is to be noted that, when a hash value equal to the received hash value exists in the hash table, since the unit data is stored already and also a leaf node has been created, the data storage node 100b omits the leaf node creation at the present step.

In this manner, the data storage node 100b performs de-duplication of data for each unit data by using a hash value.

[Step S61] The data storage node 100b creates a cache page in which the received unit data is stored into a memory such as the RAM 116 provided in the data storage node 100b. Further, after the cache page is created, the data storage node 100b stores the unit data into the storage unit 122 provided in the data storage node 100b.

It is to be noted that, if a cache page in which data is stored is created already and the data is stored in the storage unit 122, the data storage node 100b omits the cache page creation and the processing for storing data at the present step.

[Step S62] The inline execution node 100b transmits a tree update instruction to the post process execution node 100d. For example, the data storage node 100b transmits, together with the tree update instruction, an instruction to establish a link to a leaf node that includes a pointer that points to the stored unit data.

[Step S63] The post process execution node 100d establishes, in accordance with the received tree update instruction, a link that follows from the address table corresponding to the address of the data to the leaf node that includes the pointer that points to the stored unit data to update the tree structure.

Now, a relationship between the latency and the write data size in the second embodiment is described with reference to FIG. 8. FIG. 8 is a view depicting an example of a relationship between latency and a write data size in the second embodiment.

FIG. 8 is a graph depicting a relationship between the latency (μs) between the server 300 and the storage apparatus 100a and the data size (KB). For example, FIG. 8 is a graph representative of a result of measurement of the latency when one node (storage apparatus 100a) executes inline processing and post process processing with write data of a plurality of data sizes (8 KB, 16 KB, . . . , 128 KB). It is to be noted that the storage apparatus 100a is an example of one node, and the one node may otherwise be one of the other storage apparatus 100b and 100c, . . . .

The inline processing is processing for calculating a hash value for de-duplication for each piece of unit data and transmitting a write completion notification after the unit data is stored into a storage device. The post process processing is processing for transmitting a write completion notification before a hash value is calculated for each piece of unit data. Therefore, when one storage apparatus 100a executes write processing with an equal data size, the latency is shorter in the post process processing, in which the processing time period for de-duplication is not included, than in the inline processing.

However, if post process processing is executed by a plurality of nodes included in the multi-node storage apparatus 100, the load increases because the number of times of communication between nodes (between the storage apparatuses 100a, 100b, . . . ) increases in comparison with an alternative case in which inline processing is executed.

The reason why the number of times of inter-storage communication is greater in post process processing than in inline processing is that, since the post process processing provides a cache page before data is stored, also it may be required to issue a notification of an address of the cache page from the data reception node 100a to an LBA determination node and provide an instruction to update the tree. Further, since a cache page for accessing to data is created before the data is stored into a storage device, also the load in cache page creation increases.

Therefore, the multi-node storage apparatus 100 combines post process processing, whose latency is short and which is larger in number of times of inter-node communication, and inline processing, whose latency is long and which is smaller in number of times of inter-node communication, thereby achieving reduction of the load to the entire apparatus. For example, data are divided into weighted pieces of data so that the latencies in the inline processing and the post process processing become substantially equal to each other, and the processing is shared by an inline processing node and a post process processing node to reduce the latency of the entire multi-node storage apparatus 100.

A size D of write data transmitted from server 300 to the multi-node storage apparatus 100 is represented by an expression (1) given hereinbelow. Here, a data size to be allocated to the inline processing node is represented by H, and a data size to be allocated to the post process processing node is represented by L. Further, a node count indicating the number of nodes included in the multi-node storage apparatus 100 is represented by n. The node count is the number of storage apparatuses into which data received from the server 300 are stored as a processing target. It is to be noted that the node count is not limited to the number of physical units, beside may be the number of pieces of identification information with which storage apparatus may be identified or may be the number of virtual machines by which a function of a storage apparatus may be implemented or else may be the number of functions for storing the other data.

Note that it is assumed that values of H and L that satisfy a condition (A) and another condition (B) are calculated in the expression given below. The condition (A) is that one node executes post process processing and the other nodes execute inline processing. The condition (B) is that data sizes are calculated with which a plurality of nodes, that are to execute inline processing, and a single node, that is to execute post process processing, have latencies t of an equal value.

(n−1)H+L=D (1)

Further, the latency t is represented by the following expression (2) by using an inclination a_{L} of an approximate straight line between the latency and the write data size in the post process processing and an intercept b_{L} of the approximate straight line of the post process processing.

t=a_{L}L+b_{L} (2)

Further, the latency t is represented by the expression (3) given blow by using an inclination a_{H} of an approximate straight line between the latency and the write data size in the inline processing, and an intercept b_{H} of the approximate straight line of the inline processing.

t=a_{H}H+b_{H} (3)

H is represented by the following expression (4) from the expressions (1), (2), and (3).

$$H = \frac{{a}_{L} D + {b}_{L} - {b}_{H}}{{a}_{H} + ( n - 1 ) {a}_{L}} \qquad ( 4 )$$

L is represented by the following expression (5) from the expressions (1), (2), and (3).

L=D−(n−1)H (5)

Values of H and L are calculated in this manner. It is to be noted that an example in which, when the node number is “4” and D is 128 KB, H is 16 KB and L is 80 KB (portions indicated by broken lines of the graph of FIG. 8), is such as depicted in FIG. 5.

Further, the respective expressions given hereinabove are a mere example in a case where, in the multi-node storage apparatus 100, one node executes post process processing and the other nodes execute inline processing. When, in the multi-node storage apparatus 100, the number of nodes for executing incline processing and the number of nodes for executing post process processing are to be changed, the expression (1) given hereinabove may be changed in response to the change in the node count to calculate the values of H and L. Alternatively, the conditions may be changed in response to operation of the multi-node storage apparatus 100 to calculate the values of H and L by a different method.

It is to be noted that, in each node included in the multi-node storage apparatus 100, data to be used for calculation of H and L (node count, values of the latencies, a_{H}, b_{H}, a_{L}, and b_{L}) are stored in a storage unit such as the HDD 117 such that H and L may be calculated using the data.

Now, a flowchart of the data write processing in the second embodiment is described with reference to FIG. 9. FIG. 9 is a view depicting a flowchart of data write processing in the second embodiment.

The data write processing is processing in which the multi-node storage apparatus 100 receives data from the server 300 and one or more nodes provided in the multi-node storage apparatus 100 execute inline processing or post process processing to write the data.

From among the storage apparatuses 100a, 100b, 100c, 100d, . . . provided in the multi-node storage apparatus 100, a storage apparatus that receives data from the server 300 executes data write processing. Here, it is assumed that the storage apparatus 100a receives data from the server 300 and executes data write processing. It is to be noted that also the storage apparatuses 100b, 100c, 100d, . . . are capable of executing similar processing to that executed by the storage apparatus 100a.

A control unit (processor 115) provided in the storage apparatus 100a receives data from the server 300 and executes data write processing.

In the following, the storage apparatus 100a that receives data from the server 300 is referred to as data reception node 100a. Meanwhile, a storage apparatus that executes inline processing is referred to as inline execution node. Further, a storage apparatus that executes post process processing is referred to as post process execution node.

[Step S71] The data reception node 100a receives the write command and data from the server 300.

[Step S72] The data reception node 100a calculates a data size H to be allocated to the inline execution nodes (hereinafter referred to as data size H).

The data reception node 100a calculates the data size H by using the data size of the received data, a node count indicating the number of nodes provided in the multi-node storage apparatus 100, the value of the latency (for example, FIG. 8) measured in advance, and the expressions (1) to (5). It is to be noted that the data for calculation of the data size H (node count, value of the latency and so forth) are stored in the storage unit such as the HDD 117 in advance. The data reception node 100a calculates the data size H by reading out data to be used for calculation of the data size H from the storage unit.

[Step S73] The data reception node 100a determines whether or not the data size H is smaller than a threshold value determined in advance. When the data size H is smaller than the threshold value, the data reception node 100a advances its processing to step S74, but when the data size H is not smaller than the threshold value, the data reception node 100a advances its processing to step S75.

The threshold value is a value that may be set in response to operation of the storage system 400 by the system manager. The threshold value is stored in advance in a storage unit such as the HDD 117 of the storage apparatus 100a.

Since the data size H is a value calculated in response to the received data size, node count or the like, it may not necessarily be calculated as a value suitable to distribute data to a plurality of nodes to execute the processing. Depending upon the value of the data size H, such an inappropriate processing state as increase of the number of times of inter-node communication or the latency not being reduced may occur in the multi-node storage apparatus 100.

Therefore, in a case where the data size H has a value inappropriate to perform distribution and processing of data to and by a plurality of nodes, the system manager may set the threshold value so that the processing advances to step S74 in which inline processing is executed only by the data reception node 100a.

For example, in a case where the system manager sets “0” as the threshold value, if the data size H calculated at step S72 indicates a negative value, the data reception node 100a does not divide the received data and executes inline processing only by the data reception node 100a itself. Further, the system manager may set a value other than “0” (for example, “1,” “4” or the like) in response to latency measured in advance, a data size predicted in regard to a node count, reception data and so forth.

[Step S74] The data reception node 100a executes inline processing without dividing the data received from the server 300.

[Step S75] The data reception node 100a determines a post process execution node from an LBA included in the write command received from the server 300.

[Step S76] The data reception node 100a calculates a data size L to be allocated to a post process execution node (hereinafter referred to as data size L).

The data reception node 100a calculates the data size L by using the data size H determined at step S72, the data size of the data received from the server 300, and the expression (5). It is to be noted that, in the data reception node 100a, the data to be used for calculation of the data size L are stored in a storage unit such as the HDD 117.

It is to be noted that the data reception node 100a determines the data size L to a size obtained by rounding up the data size H to a multiple of the size of unit data.

For example, in a case where the size of unit data is 8 KB and the data size H is 13.8 KB, the data reception node 100a rounds up the value of the data size H to a multiple of 8 KB to calculate the data size L as 16 KB. In a case where the data size of the data received from the server 300 is 128 KB and the node count is 4, the data reception node 100a calculates the data size L by the following expression (6) obtained by substituting the values into the expression (5).

L=128−(4−1)16 (6)

From the expression (6), the data reception node 100a may calculate the data size L as 80 KB.

[Step S77] The data reception node 100a divides the data received from the server 300 into weighted pieces of data.

For example, the data reception node 100a divides the received data into one weighted division data of the data size L and (node count−1) pieces of weighted division data of the data size H. For example, when the node number is “4,” the storage apparatus 100a may divide the data received from the server 300 into one weighted division data of the data size L and three pieces of weighted division data of the data size H.

[Step S78] The data reception node 100a transmits the weighted division data and a processing command to the respective nodes.

For example, the data reception node 100a transmits the weighted division data of the data size L and an execution command of post process processing to the post process execution node determined at step S75. Further, the data reception node 100a transmits the weighted division data of the data size H and an execution command of inline processing to the nodes other than the post process execution node determined at step S75.

It is to be noted that the node that receives the execution command of inline processing from the data reception node 100a executes inline processing of the received weighted division data of the data size H. Details of the inline processing are such as described hereinabove with reference to FIG. 6. Meanwhile, the node that receives the execution command of post process processing from the data reception node 100a executes post process processing of the received weighted division data of the data size L. Details of the post process processing are such as described hereinabove with reference to FIG. 7.

[Step S79] The data reception node 100a executes inline processing of the weighted division data of the data size H, which is not transmitted to any node at step S78, from among the pieces of weighted division data divided at step S77.

Here, more detailed description is given. At step S78, the data reception node 100a transmits plural pieces of weighted division data without any overlap to the respective nodes and instructs the nodes to execute the processing. For example, it is assumed that the node count is “4” and three pieces of weighted division data (weighted division data A, weighted division data B, and weighted division data C) of the data size H and weighted division data D of the data size L exist. The data reception node 100a transmits the weighted division data B to the inline execution 100b; transmits the weighted division data C to the inline execution node 100c; and transmits the weighted division data D to the post process execution node 100d (step S78). The data reception node 100a itself executes inline processing for a piece of weighted division data A that is not transmitted to any other node.

[Step S80] The data reception node 100a receives completion notifications from the respective nodes. For example, the data reception node 100a receives a completion notification transmitted from each inline execution node (step S42) and a completion notification transmitted from the post process execution node (step S55).

[Step S81] After the inline processing and the post process processing are completed for all pieces of weighted division data, the data reception node 100a transmits a write completion notification to the server 300 and ends the data write processing.

In this manner, the multi-node storage apparatus 100 divides data and either instructs the nodes to write the data in sharing by inline processing and post process processing or executes inline processing by the data reception node to execute writing without dividing the data.

In this manner, the multi-node storage apparatus 100 determines and stores the latencies when data are written through inline processing and post process processing for each data size. The multi-node storage apparatus 100 determines data sizes to be divisionally allocated to inline execution nodes and a post process execution node, based on the stored latencies, data size received from the server 300, and node count. Further, the multi-node storage apparatus 100 determines the data sizes such that, when writing processing is executed by the inline execution nodes and the post process execution node, the latencies are equal or substantially equal to each other, and the nodes individually execute inline processing and post process processing allocated thereto.

This makes it possible for the multi-node storage apparatus 100 to reduce the latency from that when inline processing is executed otherwise by all the nodes, and reduce the number of times of inter-node communication from that when post processing is executed by all the nodes.

### Third Embodiment

Now, a third embodiment is described. In the second embodiment, data received from the server 300 are either divided into weighted pieces of data and processed in sharing by different nodes or processed only by a node that has received all data. The third embodiment is different from the second embodiment in that it includes processing for dividing data received from the server 300 into pieces of data of an equal size such that inline processing is executed by all nodes. It is to be noted that elements similar to those in the second embodiment are denoted by same reference symbols and overlapping description of them is omitted herein.

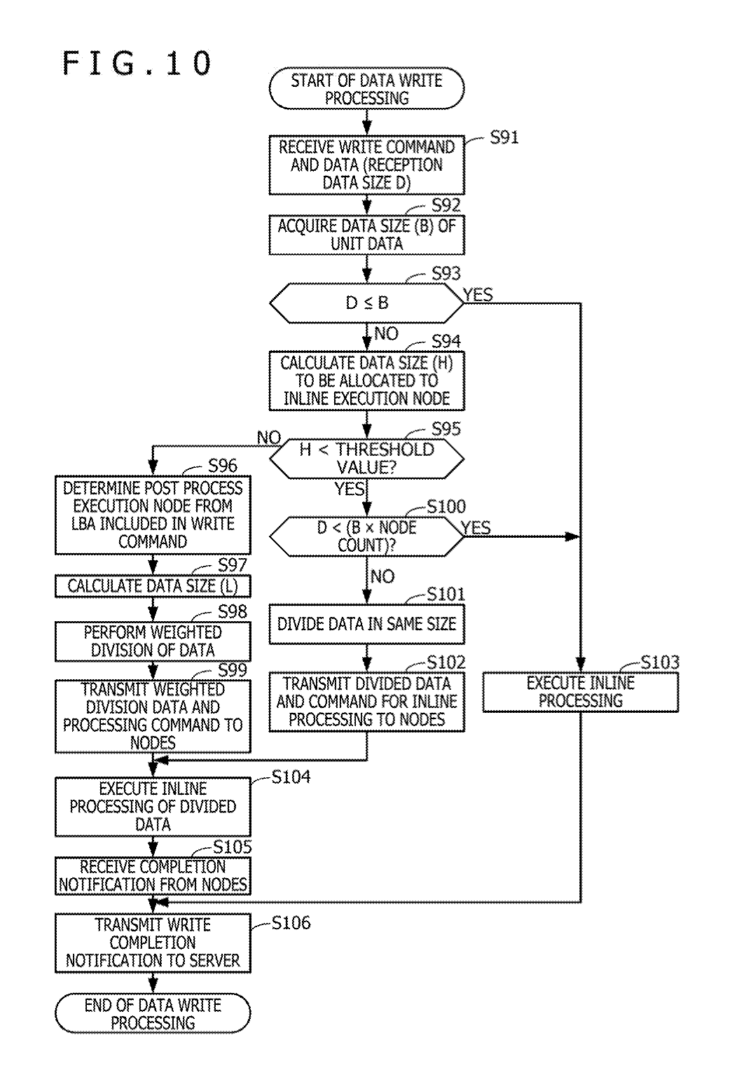

First, data write processing in the third embodiment is described with reference to FIG. 10. FIG. 10 is a view depicting a flowchart of data write processing in the third embodiment.

The data write processing is processing in which the multi-node storage apparatus 100 receives data from the server 300 and inline processing or post process processing is executed by one or more nodes provided in the multi-node storage apparatus 100 to write the data.

From among the storage apparatuses 100a, 100b, 100c, 100d, . . . provided in the multi-node storage apparatus 100, a storage apparatus that receives data from the server 300 executes data write processing. Here, it is assumed that the storage apparatus 100a receives data from the server 300 and executes data write processing. It is to be noted that also the storage apparatuses 100b, 100c, 100d, . . . may execute similar processing to that executed by the storage apparatus 100a.

A control unit (processor 115) provided in the storage apparatus 100a receives data from the server 300 and executes data write processing.

[Step S91] The data reception node 100a receives a write command and data from the server 300. In the following description, the data size of the data received from the server 300 is referred to as data size D.

[Step S92] The data reception node 100a acquires a data size of unit data. The data size of unit data is stored in a storage unit such as the HDD 117 in advance. In the following description, the data size of unit data is referred to as data size B.

[Step S93] The data reception node 100a determines whether or not the data size D is equal to or smaller than the data size B. The data reception node 100a advances its processing to step S103 when the data size D is equal to or smaller than the data size B, but advances its processing to step S94 when the data size D is not equal to or smaller than the data size B.

It is to be noted that, when the data size D is equal to or smaller than the data size B, if processing is shared by the respective nodes, the load by inter-node communication increases and the latency is not improved. Therefore, the data reception node 100a does not divide the data but itself executes inline processing without dividing the data at step S103.

[Step S94] The data reception node 100a calculates a data size H to be allocated to an inline execution node (hereinafter referred to as data size H). It is to be noted that step S94 is similar to step S72, and therefore, description of the processing is omitted herein.

[Step S95] The data reception node 100a determines whether or not the data size H is smaller than a threshold value determined in advance. The data reception node 100a advances its processing to step S100 when the data size H is smaller than the threshold value but advances its processing to step S96 when the data size H is not smaller than the threshold value. It is to be noted that step S95 is similar to step S73, and therefore, description of the processing is omitted herein.

[Step S96] The data reception node 100a determines a post process execution node, based on an LBA included in the write command received from the server 300.

[Step S97] The data reception node 100a calculates a data size L to be allocated to a post process execution node (hereinafter referred to as data size L). It is to be noted that step S97 is similar to step S76, and therefore, description of the processing is omitted herein.

[Step S98] The data reception node 100a divides the data received from the server 300 into weighted pieces of data. It is to be noted that step S98 is similar to step S77, and therefore, description of the processing is omitted herein.

[Step S99] The data reception node 100a transmits the weighted pieces of division data and a processing command to the respective nodes. It is to be noted that step S99 is similar to step S78, and therefore, description of the processing is omitted herein.

[Step S100] The data reception node 100a determines whether or not the data size D is smaller than a value obtained by multiplying the data size B by the node count. When the data size D is smaller than a value obtained by multiplying the data size B by the node count, the data reception node 100a advances its processing to step S103, but when the data size D is not smaller than the value, the data reception node 100a advances its processing to step S101.

It is to be noted that, when the data size D is smaller than the value obtained by multiplying the data size B by the node count, even if the data received from the server 300 are divided into weighted pieces of data by the data reception node 100a and the weighted pieces of data are processed by the respective nodes, the load by inter-node communication is applied and besides improvement in latency is not anticipated. Therefore, the data reception node 100a itself executes processing of the data without dividing the data.

[Step S101] The data reception node 100a divides the data received from the server 300 into pieces of data of an equal size. For example, the data reception node 100a divides the data into pieces of data of a size obtained by dividing the data size D by the node count.

[Step S102] The data reception node 100a transmits the pieces of data obtained by the division at step S101 and an inline processing command to the respective nodes, and then advances its processing to step S104.

It is to be noted that the processing at step S102 is different from the processing at step S99 in that data of an equal size and an inline processing command are transmitted to all nodes.

[Step S103] The data reception node 100a itself executes inline processing without dividing the data received from the server 300 and then advances its processing to step S106.

[Step S104] The data reception node 100a executes inline processing of a piece of data that is not transmitted to the respective nodes from among the pieces of division data.

For example, the data reception node 100a executes inline processing for a piece of data that is not transmitted to the respective nodes at step S99 from among the weighted pieces of data divided at step S98. Further, the data reception node 100a executes inline processing for a piece of data that is not transmitted to the respective nodes at step S102 from among the pieces of data of an equal size divided at step S101.

[Step S105] The data reception node 100a receives completion notifications from the respective nodes. For example, in a case where the data reception node 100a transmits weighted pieces of division data and processing commands according to the data to the respective nodes at step S99, the data reception node 100a receives a completion notification from each of the nodes to which the data and the processing commands are transmitted at step S99. Further, in a case where the data reception node 100a transmits pieces of data of an equal size obtained by the division and inline processing commands to the respective nodes at step S102, the data reception node 100a receives a completion notification from each of the nodes to which the data and the processing commands are transmitted at step S102.

[Step S106] After the processing is completed for all the pieces of data, the data reception node 100a transmits a write completion notification to the server 300 and ends the data write processing.

In this manner, in the multi-node storage apparatus 100, even if the data size H is smaller than the threshold value, if data received from the server 300 is able to be divided into pieces of data whose size is equal to the size of unit data, the received data are divided into pieces of data of an equal size and inline processing is executed by the respective nodes.

Consequently, the multi-node storage apparatus 100 may reduce the latency in comparison with a case where inline processing of all reception data is executed only by a reception node.

### Fourth Embodiment

Now, a fourth embodiment is described. In the third embodiment, the number of nodes that share processing of data received from the server 300 is a fixed value (number of storage apparatuses 100a, . . . provided in the multi-node storage apparatus 100). The fourth embodiment is different from the third embodiment in that it includes processing in which, when the data size H is smaller than a threshold value, the number of nodes to share processing is reduced and the data size H is re-calculated, and when the re-calculated data size H is greater than the threshold value, processing is shared by the reduced number of nodes. It is to be noted that elements similar to those in the second embodiment are denoted by same reference symbols and description of them is omitted herein.

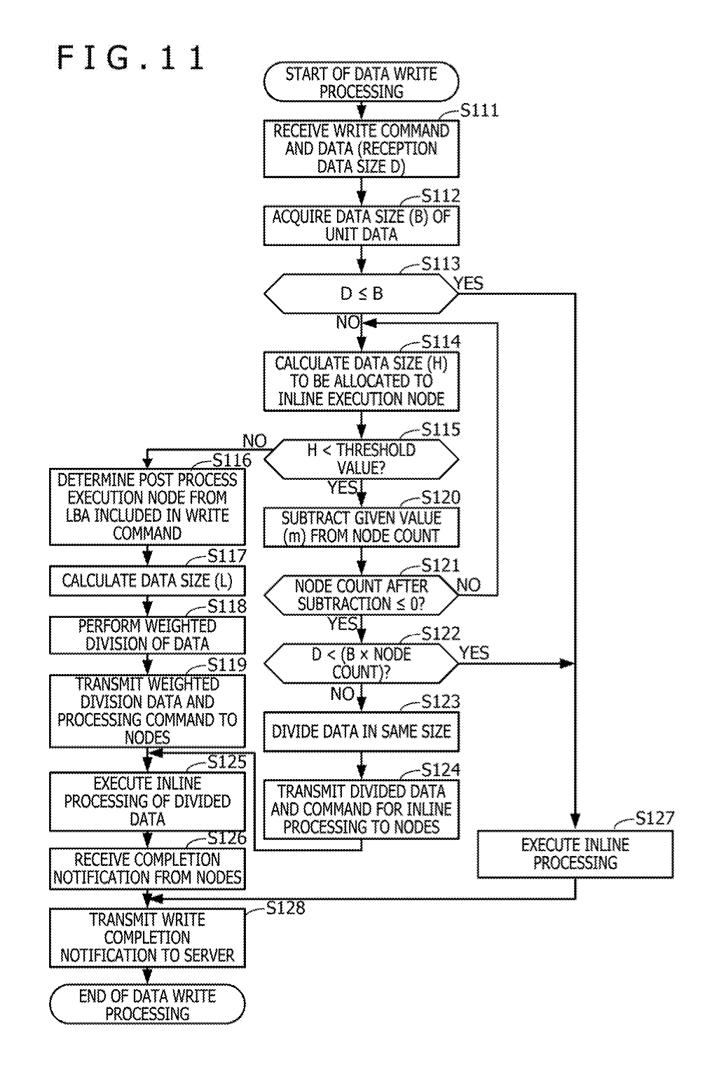

First, data write processing in the fourth embodiment is described with reference to FIG. 11. FIG. 11 is a view depicting a flowchart of data write processing in the fourth embodiment.

The data write processing is processing in which the multi-node storage apparatus 100 receives data from the server 300 and one or more nodes provided in the multi-node storage apparatus 100 execute inline processing or post process processing to write the data.

From among the storage apparatuses 100a, 100b, 100c, 100d, . . . provided in the multi-node storage apparatus 100, a storage apparatus that receives data from the server 300 executes data write processing. Here, it is assumed that the storage apparatus 100a receives the data from the server 300 and executes data write processing. It is to be noted that also the storage apparatuses 100b, 100c, 100d, . . . may execute similar processing to that executed by the storage apparatus 100a.

A control unit (processor 115) provided in the storage apparatus 100a receives data from the server 300 and executes data write processing.

[Step S111] The data reception node 100a receives a write command and data from the server 300. In the following description, the data size of data received from the server 300 is referred to as data size D.

[Step S112] The data reception node 100a acquires a data size of unit data. The data size of unit data is stored in a storage unit such as the HDD 117 in advance. In the following description, the data size of unit data is referred to as data size B.

[Step S113] The data reception node 100a determines whether or not the data size D is equal to or smaller than the data size B. When the data size D is equal to or smaller than the data size B, the data reception node 100a advances its processing to step S127. When the data size D is not equal to or smaller than the data size B, the data reception node 100a advances its processing to step S114. It is to be noted that step S113 is similar to step S93, and therefore, description of the processing is omitted herein.

[Step S114] The data reception node 100a calculates a data size H of data to be allocated to an inline execution node (hereinafter referred to as data size H).

It is to be noted that step S114 is substantially similar to step S72. However, when the node count is reduced (step S120) and the resulting node count is not equal to or smaller than “0” (NO at step S121), the data reception node 100a re-calculates the data size H by using the reduced node count.

[Step S115] The data reception node 100a determines whether or not the data size H is smaller than a threshold value determined in advance. When the data size H is smaller than the threshold value, the data reception node 100a advances its processing to step S120, but when the data size H is not smaller than the threshold value, the data reception node 100a advances its processing to step S116.

It is to be noted that step S115 is substantially similar to step S73. It is to be noted that, when the node count is reduced (step S120) and the data size H is re-calculated using the reduced node count (step S114), the data reception node 100a performs determination by using the re-calculated data size H.

[Step S116] The data reception node 100a determines a post process execution node, based on an LBA included in the write command received from the server 300.

[Step S117] The data reception node 100a calculates a data size L to be allocated to a post process execution node (hereinafter referred to as data size L).

It is to be noted that step S117 is substantially similar to step S76. It is to be noted that, when the node count is reduced (step S120) and the reduced node count is not equal to or smaller than “0” (NO at step S121), the data reception node 100a calculates the data size L by using the reduced node count.

[Step S118] The data reception node 100a weighted divides the data received from the server 300 into weighted pieces of data.

It is to be noted that step S118 is substantially similar to step S77. However, when the node count is reduced (step S120), the data reception node 100a divides the data into weighted pieces of data by using the reduced node count and the re-calculated data size H.

[Step S119] The data reception node 100a transmits the weighted pieces of division data and processing commands to the respective nodes.

It is to be noted that step S119 is substantially similar to step S78. However, in a case where the node count is reduced (step S120), the data reception node 100a transmits the weighted pieces of division data and processing commands to the nodes whose number is equal to the reduced node count.

[Step S120] The data reception node 100a obtains a value by subtracting a given value m from the node count. The given number m is a value that may be set in response to operation of the storage system 400 by the system manager. The given number m is stored in a storage unit such as the HDD 117 of the storage apparatus 100a in advance.

For example, if the number of nodes included in the multi-node storage apparatus 100 is “24,” then the system manager may set the given number m at “4.” Further, in a case where the node count is “4,” the system manager may set the given number m at “1.” It is to be noted that setting “1” or “4” to the given value m is an example, and a different value may be set.

The data reception node 100a subtracts the given number m from the node count when the present step S120 is executed for the first time. When the present step is executed for the second time, the data reception node 100a further subtracts the given number m from the value obtained by the subtraction. For example, when the node number is “24” and the given number m is “4,” the data reception node 100a determines a value by the subtraction of “24-4” for the first time, and then determines a value obtained by subtraction of “(24−4)−4” for the second time. Further, the data reception node 100a determines a value by the subtraction of “24−4×N” for the Nth time.

[Step S121] The data reception node 100a determines whether or not the node count obtained by the subtraction at step S120 is equal to or smaller than 0. When the node count obtained by the subtraction at step S120 is equal to or lower than 0, the data reception node 100a advances its processing to step S122, but when the node count obtained by the subtraction is not equal to or smaller than 0, the data reception node 100a advances its processing to step S114.

[Step S122] The data reception node 100a determines whether or not the data size D is smaller than a value obtained by multiplying the data size B by the node count. It is to be noted that the data reception node 100a multiplies the data size B by the original node count before the subtraction at step S120.

When the data size D is smaller than the value obtained by multiplying the data size B by the node count, the data reception node 100a advances its processing to step S127, but when the data size D is not smaller than the resulting value of the multiplication, the data reception node 100a advances its processing to step S123. It is to be noted that step S122 is substantially similar to step S100.

[Step S123] The data reception node 100a divides the data received from the server 300 into pieces of data of an equal size. For example, the data reception node 100a divides the data into pieces of data of a size equal to a result when the data size D is divided by the node count. It is to be noted that the data reception node 100a uses the original node count before the subtraction at step S120.

It is to be noted that step S123 is similar to step S101.

[Step S124] The data reception node 100a transmits the pieces of data obtained by the division at step S123 and inline processing commands to the respective nodes, and then advances its processing to step S125. It is to be noted that the data reception node 100a transmits the data and the inline processing commands to the nodes whose number is equal to the original number of nodes before the subtraction at step S120.

It is to be noted that step S124 is substantially similar to step S102.

[Step S125] The data reception node 100a executes inline processing of a piece of data that is not transmitted to the respective nodes from among the pieces of division data.

It is to be noted that step S125 is substantially similar to step S104.

[Step S126] The data reception node 100a receives completion notifications from the respective nodes. It is to be noted that, since step S126 is similar to step S105, description thereof is omitted herein.

[Step S127] The data reception node 100a executes inline processing without dividing the data received from the server 300, and advances its processing to step S128.

[Step S128] After processing is completed for all pieces of data, the data reception node 100a transmits a write completion notification to the server 300 and then ends the data write processing.

In this manner, in a case where, when processing is shared by all nodes, increase of the load of inter-node communication or deterioration of the latency is predicted, the multi-node storage apparatus 100 reduces the number of nodes to share and divides the data and then the processing is shared by the reduced number of nodes. Consequently, the multi-node storage apparatus 100 may suppress the load of inter-node communication and execute processing in a low latency.

### Fifth Embodiment

Now, a fifth embodiment is described. The fourth embodiment includes processing in which, when data received from the server 300 is not to be divided into weighted pieces of data, the data is divided into pieces of data of an equal size and inline processing is executed by all nodes. The fifth embodiment is different from the fourth embodiment in that it includes processing in which, when received data is not to be divided into weighted pieces of data, all the data and an inline processing command are transmitted to a node determined by an LBA included in a received write command, and inline processing of all the data is executed by the node determined by the LBA. It is to be noted that components similar to those in the second embodiment are denoted by same reference symbols, and description of them is omitted herein.

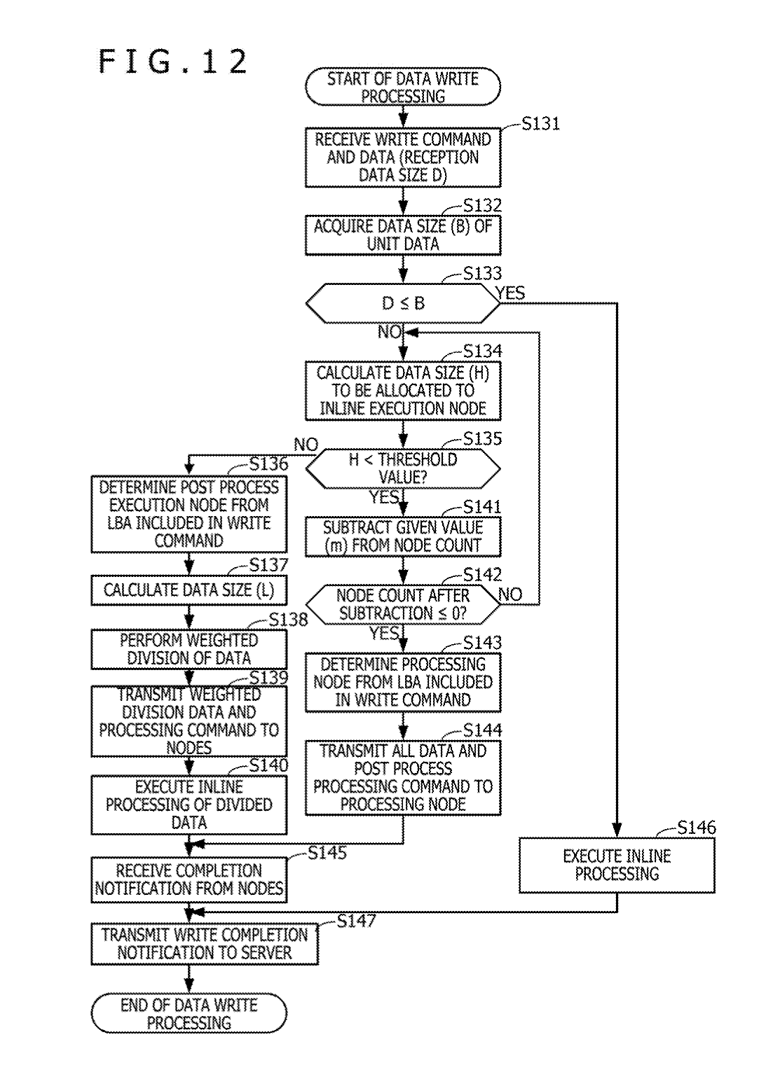

First, data write processing in the fifth embodiment is described with reference to FIG. 12. FIG. 12 is a view depicting a flowchart of data write processing in the fifth embodiment.

The data write processing is processing in which the multi-node storage apparatus 100 receives data from the server 300 and inline processing or post process processing is executed by one or more nodes provided in the multi-node storage apparatus 100 to write the data.

From among the storage apparatuses 100a, 100b, 100c, 100d, . . . provided in the multi-node storage apparatus 100, a storage apparatus that receives data from the server 300 executes data write processing. Here, it is assumed that the storage apparatus 100a receives the data form the server 300 and executes the data write processing. It is to be noted that also the storage apparatus 100b, 100c, 100d, . . . are capable of executing similar processing to that executed by the storage apparatus 100a.

A control unit (processor 115) provided in the storage apparatus 100a receives data from the server 300 and executes data write processing.

[Step S131] The data reception node 100a receives the write command and data from the server 300. In the following description, the data size of the data received from the server 300 is referred to as data size D.

[Step S132] The data reception node 100a acquires a data size of unit data. The data size of unit data is stored in a storage unit such as the HDD 117 in advance. In the following description, the data size of unit data is referred to as data size B.

[Step S133] The data reception node 100a determines whether or not the data size D is equal to or smaller than the data size B. When the data size D is equal to or smaller than the data size B, the data reception node 100a advances its processing to step S146, but when the data size D is not equal to or smaller than the data size B, the data reception node 100a advances its processing to step S134. It is to be noted that, since step S133 is similar to step S93, description thereof is omitted herein.

[Step S134] The data reception node 100a calculates a data size H to be allocated to an inline execution node (hereinafter referred to as data size H).

It is to be noted that, since step S134 is similar to step S114, description thereof is omitted herein.

[Step S135] The data reception node 100a determines whether or not the data size H is smaller than a threshold value determined in advance. When the data size H is smaller than the threshold value, the data reception node 100a advances its processing to step S141, but when the data size H is not smaller than the threshold value, the data reception node 100a advances its processing to step S136.

It is to be noted that, since step S135 is similar to step S115, description thereof is omitted herein.

[Step S136] The data reception node 100a determines a post process execution node, based on an LBA included in the write command received from the server 300.

[Step S137] The data reception node 100a calculates a data size L to be allocated to a post process execution node (hereinafter referred to as data size L).

It is to be noted that, since step S137 is similar to step S117, description thereof is omitted herein.

[Step S138] The data reception node 100a divides the data received from the server 300 into weighted pieces of data.

It is to be noted that, since step S138 is similar to step S118, description thereof is omitted herein.

[Step S139] The data reception node 100a transmits the weighted pieces of division data and processing commands to the respective nodes.

It is to be noted that, since step S139 is similar to step S119, description thereof is omitted herein.

[Step S140] The data reception node 100a executes inline processing of a piece of data that is not transmitted to the respective nodes from among the weighted pieces of division data.

It is to be noted that, since step 140 is similar to step S125.

[Step S141] The data reception node 100a obtains a value by subtracting a given value m from the node count. It is to be noted that, since step S141 is similar to step S120, description thereof is omitted herein.

[Step S142] The data reception node 100a determines whether or not the node count obtained by the subtraction at step S141 is equal to or smaller than 0. When the node count obtained by the subtraction at step S141 is equal to or smaller than 0, the data reception node 100a advances the processing to step S143, but when the node count obtained by the subtraction is not equal to or smaller than 0, the data reception node 100a advances the processing to step S134.

It is to be noted that, although the data reception node 100a determines at step S142 whether or not the node count is equal to or smaller than “0,” this is a mere example, and a device count threshold value set in advance (“0,” “1,” “2,” . . . ) may be used for determination. The device count threshold value is a value that may be set in response to operation of the storage system 400 by the system manager. The device count threshold value is stored in a storage unit such as the HDD 117 of the storage apparatus 100a in advance.

[Step S143] The data reception node 100a determines a processing node, based on an LBA included in the write command received from the server 300.

[Step S144] The data reception node 100a transmits all the data and an execution command of post process processing to the processing node determined at step S143 without dividing the data received from the server 300. It is to be noted that the processing node executes post process processing for the data received from the data reception node 100a.

[Step S145] The data reception node 100a receives completion notifications from the respective nodes. It is to be noted that, since step S145 is similar to step S105, description thereof is omitted herein.

[Step S146] The data reception node 100a executes inline processing without dividing the data received from the server 300 and then advances its processing to step S147.

[Step S147] The data reception node 100a transmits, after processing is completed for all the data, a write completion notification to the server 300 and then ends the data write processing.

In this manner, in the multi-node storage apparatus 100, when data received from the server 300 is not to be divided into weighted pieces of data, a node determined by the LBA executes post process processing for all the data. Consequently, when the data transfer performance between nodes is high and the data processing speed in each node is low, the multi-node storage apparatus 100 performs processing in a low latency and may achieve improvement in performance.

In this manner, in the storage system 400, inline processing or post process processing is executed by one or more nodes in response to the data size of data whose writing is commanded by the server 300, the number of nodes provided in the multi-node storage apparatus 100, or the latency measured in advance. Further, the storage system 400 determines data sizes such that, when inline execution nodes and a post process execution node execute writing processing, the latencies in them are balanced, and inline processing or post process processing is executed by one or more nodes.

In this manner, when data are stored in a distributed manner by a plurality of nodes (storage apparatus 100a, . . . ) provided in the multi-node storage apparatus 100, the load of inter-node communication may be suppressed while the latency involved in de-duplication processing is suppressed.

The storage system 400 may suppress the load of inter-node communication while suppressing the latency involved in de-duplication processing when data are stored into storage devices.

It is to be noted that the processing functions described above may be implemented by a computer. In this case, a program is provided which describes the substance of processing for functions to be provided for the information processing apparatuses 10, 20, 30, . . . and the storage apparatuses 100a, 100b, 100c, 100d, . . . . The program is executed by the computer to implement the above-described processing functions on the computer. The program that describes the processing substance may be recorded in a computer-readable recording medium. As the computer-readable recording medium, there are a magnetic storage device, an optical disk, a magneto-optical recording medium, a semiconductor memory and so forth. As the magnetic recording device, there are a hard disk drive (HDD), a flexible disk (FD), a magnetic tape and so forth. As the optical disk, there are a DVD, a DVD-RAM, a CD-ROM/RW and so forth. As the magneto-optical recording medium, there are a magneto-optical (MO) disk and so forth.

In a case where the program is to be distributed, a portable recording medium such as a DVD or a CD-ROM on which the program is recorded is sold. Also it is possible to store the program into a storage device of a server computer or the like and transfer the program from the server computer to a different computer through a network.

A computer that is to execute a program stores the program recorded on the portable recording medium or transferred from the server computer into an own storage device of the computer. Then, the computer may read the program from the own storage device and execute processing in accordance with the program. It is to be noted that the computer may read the program from the portable recording medium directly and execute processing in accordance with the program. Also it is possible for the computer to successively execute, every time the program is transferred from the server computer coupled thereto through a network, processing in accordance with the received program.

Further, it is possible to implement at least part of the above-described processing functions by electronic circuitry such as a DSP, an ASIC, or a PLD.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An apparatus in an information processing system in which a plurality of apparatuses are coupled to each other through a network so as to enable data de-duplicated by post process processing or inline processing to be stored in a distributed manner into storage devices provided for the plurality of apparatuses, the apparatus comprising:
a memory configured to store apparatus information identifying the plurality of apparatuses and performance information of post process processing and inline processing in the apparatus; and
a processor coupled to the memory and configured to:
upon reception of a storage instruction for storing storage target data into a storage destination, calculate, based on a data size of the storage target data, the performance information, and the apparatus information, a first data size of first data that is a processing target in the post process processing and a second data size of second data that is a processing target in the inline processing such that first latency by the post process processing and second latency by the inline processing are balanced with each other,
specify a first apparatus including management information of the storage target data from the storage destination,
instruct the first apparatus to execute the post process processing whose processing target is the first data of the first data size within the storage target data, and
instruct at least one second apparatus other than the first apparatus to execute the inline processing whose processing target is the second data of the second data size within the storage target data.

2. The apparatus of claim 1, wherein
the processor is further configured to:
instruct, when the calculated second data size is greater than a threshold value set in advance, the first apparatus to execute the post process processing whose processing target is the first data of the first data size within the storage target data, and instruct the at least one second apparatus other than the first apparatus to execute the inline processing whose processing target is the second data of the second data size within the storage target data, and
execute, when the calculated second data size is smaller than the threshold value, the inline processing whose processing target is the storage target data.

3. The apparatus of claim 1, wherein
the processor is further configured to execute, when a data size of the storage target data accepted through the storage instruction is smaller than a given data size, the inline processing whose processing target is the storage target data.

4. The apparatus of claim 1, wherein:
the apparatus information is configured to specify one or more execution target apparatuses each being an apparatus on which the post process processing or the inline processing to be performed; and
the processor is further configured to:
specify an apparatus count indicating a number of the one or more execution target apparatuses from the apparatus information,
divide, when the calculated second data size is smaller than a threshold value set in advance and a data size of the storage target data is greater than a value obtained by multiplying a given data size by the apparatus count, the storage target data into pieces of data whose number is equal to the apparatus count so that sizes of the divided pieces of data are equalized among the one or more execution target apparatuses, and
instruct the one or more execution target apparatuses to execute the inline processing whose processing targets are the respective pieces of data divided from the storage target data.

5. The apparatus of claim 1, wherein:
the apparatus information is configured to specify one or more execution target apparatuses each being an apparatus on which the post process processing or the inline processing to be performed; and
the processor is further configured to:
specify an apparatus count indicating a number of the one or more execution target apparatuses from the apparatus information,
determine, when the calculated second data size is smaller than a threshold value set in advance, a value obtained by subtracting a given value set in advance from the apparatus count as a new apparatus count indicating a number of one or more new execution target apparatuses on which the post process processing or the inline processing to be performed, and
calculate the first data size and the second data size, based on a data size of the storage target data, the performance information, and the new apparatus count such that latency by the post process processing and latency by the inline processing are balanced with each other.

6. The apparatus of claim 1, wherein:
the apparatus information is configured to specify one or more execution target apparatuses each being an apparatus on which the post process processing or the inline processing to be performed; and
the processor is further configured to:
specify an apparatus count indicating a number of the one or more execution target apparatuses from the apparatus information,
determine, when the calculated second data size is smaller than a threshold value set in advance, a value obtained by subtracting a given value set in advance from the apparatus count as a new apparatus count indicating a number of one or more new execution target apparatuses, and
specify, when the new apparatus count is equal to or smaller than an apparatus count threshold value set in advance, a first apparatus including management information of the storage target data from the storage destination, and instruct the first apparatus to execute the post process processing whose processing target is the storage target data.

7. A method performed in an information processing system in which a plurality of apparatuses are coupled to each other through a network so as to enable data de-duplicated by post process processing or inline processing to be stored in a distributed manner into storage devices provided for the plurality of apparatuses, the method comprising:
providing apparatus information identifying the plurality of apparatuses and performance information of post process processing and inline processing in the apparatus;
upon reception of a storage instruction for storing storage target data into a storage destination, calculating, based on a data size of the storage target data, the performance information, and the apparatus information, a first data size of first data that is a processing target in the post process processing and a second data size of second data that is a processing target in the inline processing such that first latency by the post process processing and second latency by the inline processing are balanced with each other;
specifying a first apparatus including management information of the storage target data from the storage destination;
instructing the first apparatus to execute the post process processing whose processing target is the first data of the first data size within the storage target data; and
instructing at least one second apparatus other than the first apparatus to execute the inline processing whose processing target is the second data of the second data size within the storage target data.

8. A non-transitory, computer-readable recording medium having stored therein a program for causing a computer to execute a process, the computer being included in an information processing system in which a plurality of apparatuses are coupled to each other through a network so as to enable data de-duplicated by post process processing or inline processing to be stored in a distributed manner into storage devices provided for the plurality of apparatuses, the process comprising:
providing apparatus information identifying the plurality of apparatuses and performance information of post process processing and inline processing in the apparatus;
upon reception of a storage instruction for storing storage target data into a storage destination, calculating, based on a data size of the storage target data, the performance information, and the apparatus information, a first data size of first data that is a processing target in the post process processing and a second data size of second data that is a processing target in the inline processing such that first latency by the post process processing and second latency by the inline processing are balanced with each other;
specifying a first apparatus including management information of the storage target data from the storage destination;
instructing the first apparatus to execute the post process processing whose processing target is the first data of the first data size within the storage target data; and
instructing at least one second apparatus other than the first apparatus to execute the inline processing whose processing target is the second data of the second data size within the storage target data.
